(19) United States
(12) Patent Application Publication
(10) Pub. No.: US 2023/0376791 A9
(43) Pub. Date: Nov. 23, 2023

(54) System and Method for Generating Decision Confidence Index Scores and Bias Assessment Scores for Interactive Decision-Making

(71) Applicants: James Tobias Reiley, Marblehead, MA (US); Wayne Mariner Kennard, Natick, MA (US)

(72) Inventors: James Tobias Reiley, Marblehead, MA (US); Wayne Mariner Kennard, Natick, MA (US)

(21) Appl. No.: 17/300,561

(22) Filed: Aug. 19, 2021

Related U.S. Application Data
(60) Provisional application No. 63/103,701, filed on Aug. 19, 2020.

(51) Int. Cl. G06N 5/02; G06K 9/62; G06N 20/00

(52) U.S. Cl. CPC G06N 5/022; G06K 9/6251; G06K 9/6265; G06N 20/00

(57) ABSTRACT

A computer-based decisioning tool is disclosed that enables the generation of Bias Assessment Scores to indicate a level of hidden or unconscious bias an individual being tested may have and enables the generation of Confidence Index Scores the indicate the best choices for making three types of decisions, which are searching/match decisions, comparison decisions, and binary (Yes/No) decisions.

### CROSS-REFERENCES TO RELATED APPLICATIONS

This Application claims the benefit under 35 U.S.C. 119 (e) to U.S. Provisional Patent Application No. 63/103,701, filed Aug. 19, 2020, the entirety of which is explicitly incorporated herein by reference.

All publications, patent applications, patents, or other references mentioned herein are incorporated by reference in their entirety. The patent and scientific literature referred to herein establishes knowledge that is available to those skilled in the art. The issued patents, applications, and other publications that are cited herein are hereby incorporated by reference to the same extent as if each was specifically and individually indicated to be incorporated by reference. In the case of inconsistencies, the present disclosure will prevail.

### FIELD OF THE INVENTION

The present invention generally relates to computer-based systems and methods used for (1) conducting bias assessments and (2) decision-making. More specifically, the present invention relates to computer-based systems and methods used for (1) conducting bias assessments that result in the generation of numeric scores representing the level of hidden or unconscious bias in the person being tested relating to a specific subject area and (2) decision-making that results in the generation of numeric scores representing the level of confidence the decision maker may have in the options available for a specific decision.

### BACKGROUND OF THE INVENTION

At different times institutions, affinity groups, governmental agencies, for-profit and nonprofit corporations ranging from small businesses to large enterprises (referred to collectively as “Organizations”) and individuals have to face two things: (1) recognition that bias exists and it must be identified, understood, and addressed and (2) decisions are made in light of a given set of facts and these facts are applied to the available decision options in the hope of the arriving at the best decision for the individual or Organization.

Currently, to the extent there are computer-based tools to address bias in people or assist in decision-making, they are two distinct tools. Starting first with bias assessment, most methods to address bias are not computer-based at all but address it through general bias training seminars, conferences, and case studies. Generally, these approaches do not seek to directly address bias in each individual person but generally make individuals and groups (large and small) aware of the existence of bias on a macro level to drive conversations about bias. Usually, the implementation of these methods of addressing bias is mandated or pursued by an Organization's management in the face of a bias lawsuit being leveled against it, as a recruiting tool to attract the best employees or group members, to appear to be more proactive on the subject of bias than competitors, the existence of general concerns about bias in an Organization or group having been reported to management, or it has become an industry or group standard to conduct this type of training on a periodic basis with little thought of the changing nature of bias or the makeup of the employee or group base.

These more rote methods of attempting to address bias in individuals or an Organization's members are limited in a number of ways. Much of this type of bias training only has roots in the DEI (“Diversity, Equity, and Inclusion”) arena. And, as such, the focus of this training lends itself to seminars, workshops, and case studies to delve individuals and Organization members into a world that injects them into the shoes of people experiencing bias based on race, gender, gender identity, ethnicity, and countries of origin. Bias training with this type of focus has not lent itself to computer-based methods other than to collect and present data. This training also was not interactive computer-based training that looked at each individual or Organization member as individual people even with respect to these few specific types of bias but again presented them with training geared to group-type presentations.

To the extent there has been some types of computer-based methods with a focus on bias, one of the most well-known is the Harvard Implicit Association Test (“IAT”), which can focus on thirteen (14) bias areas. These are Religion, Arab-Muslim, Gender-Science, Skin-tone, Age, Asian, Gender-Career, Weight, Presidents, Sexuality, Weapons, Transgender, Disability, and Race. The mission of the Harvard project is to educate the public about bias and to produce a “virtual laboratory” for collecting data over the internet and producing research that forms the basis for scientific knowledge about bias and disparities. The Harvard test measures attitudes and beliefs that people may be unwilling or unable to report. It may also show implicit attitudes you did not know about. In taking a test, the results will be what the selections indicate is a bias related to the selected subject area. However, there is no activity beyond the data collection for the test taker.

Another computer-based method associated with bias includes tools that allege to have an “Unconscious Bias Detector.” Tools of this type have a company input a list of employees and their demographic information along with a set of performance reviews about them. These tools use “socio-linguistic hypergraph” technology to understand the context and patterns within the documents to detect patterns of potential bias. However, this type of bias detection does not provide comprehensive measurements of bias.

A yet another type of tool associated with bias has been used as a diversity recruiting tool. These tools hide things like names, age, employment history, background, and photos from resumes. They then help with sourcing by broadening the search for talented and qualified candidates, racial bias aside. These tools seem to ignore areas of bias in recruiting rather than facing and addressing them.

Noting the current systems and methods, such as those described above, they do not provide for a computer-based system that is capable of separately evaluating each individual or Organization member for any of a large number of different hidden or unconscious biases and generating a numeric score for each bias being assessed and then comparing that score against a target score to determine how the individual or Organization member differs from the target for determining acceptable or unacceptable levels of hidden or unconscious bias in the individual or Organization member.

When it comes to making decisions, individuals and Organizations make a large number of them based on things like “gut-feeling,” “that's how we did it last time,” “anecdotal information,” or “I just had to choose something.” These and other similar methods have led to some good decisions that have worked out fine but also a large number of bad or ineffective ones that required much more work and time, loss of revenues, and loss of opportunities because of the ripple effect the impact of these poor decisions had on the individual or Organization.

Considering decision-making, there are a number of current computer-bases systems and methods that are in the category of decisioning tools. Many of these tools are ones that are used to align or build consensus among groups of people, such as corporate teams. These are referred to as collaboration platforms. Once consensus is reached, the group can use the agreed-upon decision path to follow. These current collaborative systems and methods can also be in the form of predictive engines that track the actions of users and based on this history provide predictions as to what these users will want in the future.

When considering the types of decisions individuals and Organizations regularly make, a large number fall into the categories of “searching/match,” “comparison,” and binary (Yes/No)” decisions. A number of currently available computer-based decision-making tools are decision engines that tend to look only at static information the parties to these decisions enter into the system and do not look for other additional information that addresses the dynamic decision environment. Therefore, as things change during the decision-making process, the changed conditions cannot be readily incorporated without restarting the whole process. And, if the decision process is not computer software based, there is a tendency for things to be forgotten over time as the decision process plays out. Either way, these are less than efficient and effective ways to make large and small decisions.

The decisioning tools that are currently available include ones that not only help with decision-making but also prioritization of decision options, and understanding stakeholder preferences, with the later coming from questions the system asks the users. Some of the tools that include prioritization also can factor in hidden agendas, decision bias, and nonaligned goals in the decision process. Further, some tools attempt to help the decision-making process by stripping away business subjectivity and human bias and rely solely on the decision data that is provided to the users.

The variety of decisioning tools includes ones that help make structured decisions considering a number of available options that are compared to a set of criteria. The group of decision participants report their individual evaluation scores, which are consolidated into an overall scorecard for the group. This is another form of a consensus or collaboration platform.

Another decisioning tool that uses scoring in the decision-making process is a discussion analyzer that calculates a score based on the weighted agreement level of a group towards the content as well as based on understanding the thought distance between group member scores, and the patterns of agreements and disagreements between group members.

These current decisioning tools have a number of disparate features as indicated above. However, they do not provide the user with a decision-making tool that enables the user to generate a numeric score based on what the user considers important, an ability to change the decision option ranking order based on interactive questioning within the decision-making process, or have the ability to process a variety of types of decisions including, but not limited to searching/match, comparison, and binary (Yes/No) decisions.

The present invention provides a new and novel computer-based decisioning tool that can be used for bias assessment and decision-making and improve on existing dedicated computer-based or noncomputer-based bias assessment tools and computer-based decision-making tools. This will be shown in the remainder of this specification with reference to the Figures and the claims as filed and as they exist in a patent that issues here from.

### SUMMARY OF THE INVENTION

The systems and methods of the present invention are directed to a computer-based decisioning tool useful for generating (1) numeric bias assessment scores for individuals as themselves or individuals as a member of a group or Organization that indicates their levels of unconscious or hidden bias evaluated against acceptable numeric societal ranges generated by a subject matter expert (“SME”) and (2) decision-making numeric confidence index scores for ranking which of a number of decision options is best for a system user to take given the current circumstances associated with each option, the user's goals and priorities, and any interactive communications between the system user and potential target(s) in the decision-making process.

The computer-based decisioning tool according to the present invention incorporates bias assessment and decision-making in a single computer-based system. Besides the generation of numeric scores for the two separate areas (bias assessment and decision-making), the system user is also able to identify unconscious or hidden bias in decision criteria under consideration and use these bias assessment findings to improve decision-making.

The computer-based decisioning tool of the present invention operates according to the structure of three basic elements: Bias Assessment/Decision Profiles, Objects, and Dimensions. In general, a Bias Assessment/Decision Profile defines the user and subject area; that is, regarding the latter, specifying the general area for a bias assessment investigation or decision-making. In bias assessment, Profiles include information about the person being assessed and defines that person through a series of questions focused on the bias area of concern. In decision-making, Profiles include user information about the person performing decision-making and their goals and priorities that will be incorporated in the decision process. Objects are the main inquiries associated with each question being asked in a template used to elicit information from the person being assessed or making a decision. Dimensions are sub-inquiries of the Object from which they stem. Each Profile may have multiple Objects and each Object may have multiple Dimensions.

In the context of bias assessment, the computer-based decisioning tool of the present invention enables individuals and Organizations to carry out bias assessments to discover hidden or unconscious bias that exists in such individuals or an Organization's members in a wide range of subject areas. Bias assessment according to the present invention is not limited to the typical areas people associate with bias assessment, such as race, gender, gender identity, ethnicity, and country of origin. The present invention's bias assessment testing provides a numeric bias assessment score indicating the user's hidden or unconscious bias with respect to the specific subject area under test, which may be in one of the most thought of areas of bias assessment such as race, gender, gender identity, ethnicity, and country of origin, but also subject areas like food, areas of the country to live, transportation modes and vehicles, and education methods to name a few.

According to the present invention, the process for bias assessment begins with the selection of the subject area for which unconscious or hidden bias is to be assessed. At this point, a template developed by a subject matter expert (“SME”) in that particular area provides questions to be answered by the individual being assessed according to the category in which the individual is placed, of which, preferably there are two: (1) the individual in his/her sole capacity or (2) as a member of an Organization. In the first category, the SME template questions will be directed to the selected bias subject area without additional input. In the second category, the SME template questions will be directed to the selected bias subject area but with input from the Organization. The individual's answers to the SME template questions generates a Bias Profile for that individual being tested.

If the individual being assessed is in his/her own individual capacity and not as part of an Organization, the SME template questions will be transmitted to the individual to elicit his/her responses to the two parts for each question in the context of the particular bias area being investigated. Preferably, the first part is the question itself that is answered based on a numeric scale, for example, between 0 to 100. The second part is the “importance” of the question to the individual that is also answered based on a numeric scale, for example, between 0 to 100.

In the case where the individual being evaluated for unconscious or hidden bias is associated with an Organization and the Organization is doing the bias assessment investigation, the SME will submit the template questions to a representative of the Organization who will review them and may add or remove certain questions. The Organization will also set an Organization's target score for each of the two parts of each question. These target scores are the Organization's preferred scores and used to evaluate their member responses. Once this has been done, the Organization will transmit the questions to the members being assessed to answer the questions; however, the members will not see the Organization targets when answering the questions.

Whether it is the individual in his/her own capacity or a member of an Organization being assessed, when the SME develops the template, the SME will also generate an acceptable societal range for each of the two parts of each question. These societal ranges will not be provided to the individual being assessed for hidden or unconscious bias whether acting in his/her sole capacity or as a member of an Organization.

The individual responding to the template questions will return the numeric responses to the entity who provided them for analysis regarding indications of his/her hidden or unconscious biases. The numeric responses are processed according to present invention and two types of scores will be generated. The first is a numeric bias assessment score for each part of a question and, the second, a composite numeric bias assessment score that indicates the individual's hidden or unconscious bias(es) associated with the bias subject area being assessed. These two types of scores may have numeric values, for example, also from 0 to 100.

With regard to the acceptable societal ranges, the SME will generate them at the beginning of the process of the present invention when the template is developed. If the individual's bias assessment score falls within that range or outside the range will now be briefly discussed.

In the case of the individual acting in his/her own capacity, the bias assessment scores for each question (Object or Dimension) and composite bias assessment score for the overall template will inform that individual of his/her level of hidden or unconscious bias in the bias subject area and whether the scores fall within or outside the acceptable societal ranges established by the applicable SME. If the score is within the acceptable societal range the individual should see where it falls in the range to understand his/her hidden or unconscious biases. However, if the score is outside the acceptable societal range, then the individual may consider seeking help to address the identified areas of unacceptable levels of hidden or unconscious bias.

In the case of individuals who are members of an Organization, the level of hidden or unconscious bias indicated by the scores for each question and the composite score can raise issues if they fall outside the SME's societal acceptable ranges. This may inform the Organization it may need to take some type of remedial actions to address these findings, for example, such as, providing some level of training to address the identified hidden or unconscious bias and, in extreme cases, it may mean separating that individual from the Organization.

Also, with regard to members of an Organization being assessed, the individual member's scores on each question and the composite score will be compared to the target score the Organization has determined it desires its members have. In evaluating the member's scores for each question and the composite score, the greater the distance the member's score deviates from the target score, the greater concern it may be for the Organization for the member's hidden or unconscious biases.

The computer-based decisioning tool of the present invention is also a decision engine that generates a confidence index score to indicate the level of confidence a system user may have in each of the available decision options presented to him/her under the current fact environment to solve his/her/its needs. Preferably, there are three decision types processed by the decision engine. These include searching/match decisions, comparison decisions, and binary (Yes/No) decisions. Preferably, each decision type is processed in substantially the same way but differ to some extent.

First, searching/match decisions, typically, are between two parties. At least one of these parties is a system user. Second, comparison decisions are where the system user is choosing between more than two decision options. And, third, binary decisions (Yes/No) are ones in which the system user must decide whether to accept or decline a specific subject product, a path in which to proceed, or a process to implement, to name a few.

Regarding each decision type, they operate using the three aforementioned elements: Profiles, Objects, and Dimensions. In the case of searching/match decisions, Profiles may include system user demographic information, the decision area, and the user's goals and priorities relating to the decision. Objects include top level searching queries that incorporate the user's goals and priorities. Dimensions include sub-level searching queries that also incorporate the user's goals and priorities.

The Objects and Dimensions are processed by a search engine for generating matches. The matches that are returned are ranked according to the confidence index score generated according the matching algorithm of the present invention. The ranking is preferably from the highest score to a lower cutoff score. At this point in the process, the system user and the matched entities are anonymous to each other.

Once the ranking of confidence index scores and any associated bias assessment is reviewed, the system user can send one or more of the matched parties a direct message asking additional question(s) to determine the actual best match for the system user. The responses to the questions when processed by the system of the present invention can change the initial ranking. The ranking may also be changed by questions sent by one of the matched entities to the system user. The process is iterative. And multiple iterations are allowed. After all of the questions have been processed, a final ranking will be generated.

Once the final ranking is generated, the system user and the matched parties are still anonymous to each other. In order to proceed further, the system user and a chosen match will have to agree to disclose their identity to each other. If one of these parties does not agree to do this, then the process will stop between these parties. If this happens, the system user may then decide to go to the next highest match in the ranking and go through the disclosure procedure as stated above. If both of these parties agree to disclosing their identities, then the parties carry out the disclosure and negotiate any contract or deal the parties want to enter.

Regarding comparison decisions, as stated, they operate using Profiles, Object, and Dimensions. This type of decision is a one-to-many decision process. Profiles may include system user demographic information, the decision area, and the goals and priorities of the system user. Objects may include the listings of the products, persons, objects, services, etc. to be compared alone with the features of each of them. Alternatively, the system user can issue a request for proposals for products, persons, objects, services, etc. to return information about such items or people. Dimensions may include sub-information with regard to the products, persons, objects, services, etc. being compared. The Objects and Dimensions take into account the system user's goals and priorities.

The features of the products, persons, objects, services, etc. being compared are compared against the system user's Objects and Dimensions, and a confidence index score is generated for each. Then, the products, persons, objects, services, etc. are ranked according to the scores. The ranking may be changed by the system user receiving additional information about the product, person object, or services purveyors or people that are members of the group being compared. Additionally, the source of the goods, services, or people under consideration may be contacted by the system user to provide additional information. These sources may provide this information to the system user. This new information is processed by the decision engine and it may change the confidence index scores and, therefore, the ranking.

In the case of comparison decisions, anonymity is only on the side of the systems user not with respect to the products, persons, objects, services, etc. being compared. If the system user decides to choose one of the ranked candidates, the system user may reveal his/her identity and proceed to enter a contract or deal with the candidate.

Binary (Yes/No) decisions, like the other two decision types, operate using Profiles, Objects, and Dimensions. These types of decisions are sometimes called “Y” juncture decisions. Profiles for this decision type may include system user's demographic, the decision area, and the goals and priorities. Objects may include the inquiries relating the top-level features of the two decision paths. Dimensions may include sub-level inquiries relating to specific Objects.

The system user may amass information about each choice through inquiries based on the Objects and Dimensions. This information may be processed by the decision engine to generate a confidence index score for each of the binary options. Whenever possible, the system user may seek information from third parties about the two choices. These third parties may include an entity who is an interested party with respect to the one or both of the options, and this may be factored in to weigh that information. Once the decision engine processes the amassed information and the confidence index scores have be adjusted, if at all, the user may then choose which of the paths to select.

With this third type of decision, there may be anonymity with respect to the system user. The identity of the system user will only be revealed, if, and only if, the system user wants to reveal his/her/its identity. To the extent there is an entity associated with either of the two options who is capable of transmitting and responding to inquiries, there may or may not be anonymity with respect to that entity. After the system user chooses one of the binary options, the system user my proceed to follow that choice or, where necessary, enter a contract or deal to pursue that choice.

The structure of the decisioning tool of the present invention for performing both bias assessment and decision-making includes a security shell that receives inputs from the system users and parties to bias assessments and decisions to protect this information from disclosure to any third parties and to other system users. A security shell of this type is used because the potential nature of the type of information that may be processed by the system of the present invention that may include financial information, medical information, very personal information, to name a few types. Further, the security shell shall not release any information from it until these entities specifically assent to the disclose. That is, the only information output from the shell only may be done by the express authorization of the entity who owns it or an entity authorized to release it. Otherwise, it will remain in the security shell. Finally, to the extent information is output from the security shell, it may be only in the form of results not any of the raw data processed by the decisioning tool according to the operation algorithms for bias assessment and decision-making.

The decisioning tool of the present invention will now be described in greater detail in the remainder of the specification referring to the drawings and the claims.

### BRIEF DESCRIPTION OF THE DRAWINGS

FIG. 1 shows a representative flow diagram of a system user's selection of the operation he/she wants to do with the decisioning tool.

FIG. 2 shows a representative flow diagram of a method of generating bias assessment scores as an individual in his/her own capacity and as a member of an Organization.

FIG. 3 shows a representative flow diagram of a method used to engage SMEs and for SMEs to develop templates for bias assessment and decision-making.

FIG. 4A shows a representative Bias Profile template and a Bias Object, multiple Bias Dimensions associated with the Bias Object, and a system user's responses to the Bias Dimension questions.

FIG. 4B shows the representative Bias Profile template in FIGS. 4A with SME socially acceptable societal ranges added.

FIG. 4C shows the representative Bia Profile template in FIG. 4B with an Organization's desired member responses added.

FIG. 5 shows a representative distribution of responses of a group of Organization members with respect to a single Bias Dimension question.

FIG. 6 shows a representative drawing of aggregating three Bias Dimension distributions to generate a Bias Object distribution.

FIG. 7 shows a representative drawing of the aggregation of Bias Object distributions with their priority weighting (importance) for generating a composite distribution and score for a Bias Assessment Profile subject area under investigation, such as shown in FIG. 8.

FIG. 8 shows a representative composite distribution and score for a Bias Assessment Profile subject area under investigation.

FIGS. 9A, 9B, and 9C show a representative flow diagram of the method for carrying out searching/match decisions.

FIG. 10A shows a representative Decision Profile, Decision Object, and two Decision Dimensions for the Decision Object.

FIG. 10B shows the Decision Profile, Decision Object, and two Decision Dimensions in FIG. 10A with the representative scores for matching in the search conducted by a system user looking for best roommate match for him/her.

FIG. 10C shows a representation set of ranked results of matching targets identified in the search with their anonymous ID, initial Confidence Index Scores, and new Confidence Index Scores after one or more supplemental question exchanges between the system user and one or more identified matching targets.

FIGS. 11A, 11B, and 11C show a representative flow diagram of the method for carrying out comparison decisions.

FIG. 12A shows a representative Decision Profile, Decision Object, and three Decision Dimensions relating to the subject area “Compare SUVs for Street and Off-Road (Dual Use).”

FIG. 12B shows a representative table of data relating to the Decision Dimensions in FIG. 12A.

FIGS. 13A, 13B, and 13C show a representative flow diagram of the method for carrying out binary (Yes/No) decisions.

FIGS. 14A, 14B, 14C, and 14D show a representative method for generating Confidence Index Scores and Bias Assessment Scores.

FIG. 15 shows a representative method for generating Importance Factor Scores.

FIG. 16 shows a representative diagram of the Multi-Layered Secure Data Shell of the present invention.

FIG. 17 shows a representative system for carrying out the method of the present invention.

### DESCRIPTION OF THE PRESENT INVENTION

The present invention is a system and method directed to a computer-based decisioning tool that is capable of carrying out two distinct functions in a single tool. These functions include generating (1) numeric bias assessment scores for measuring the level of an individual's or Organization member's unconscious or hidden bias measured against acceptable numeric societal ranges generated by SMEs and (2) decision-making numeric confidence index scores for ranking which of a number of decision options is best for a system user to take given the current circumstances associated with each option, the user's goals and priorities, and any interactive communications between the system user and the potential target in the decision-making process.

The intent of the bias assessment according to the present invention is to identify the level of hidden or unconscious bias that a person may have. This may be done by an individual in his/her own capacity or When that person is a member of an Organization. As stated previously, as used herein, an “Organization” is meant to be representative of institutions, affinity groups, governmental agencies, for-profit/nonprofit corporations ranging from small businesses to large enterprises.

As will be described in greater detail herein, the decisioning tool of the present invention will carry out both bias assessment and decision-making processes through the use of Profiles, Objects, and Dimensions. For clarity, the respective “Profiles” for these two distinct functions of the decisioning tool will hereinafter be referred to as “Bias Profiles” and “Decision Profiles” to prevent confusion. The difference between the two Profiles types is a “Bias Profile” preferably is what is generated based on the person being assessed's answers to a series of questions from a SME template for identifying hidden or unconscious bias, while “Decision Profile” preferably includes a number of system user created Decision Objects inquiries and Decision Dimensions inquiries for generating a decision.

Following the differences between two types of Profiles, the Objects and Dimensions for bias assessment and decision-making also differ. “Bias Objects” and “Bias Dimensions” are respectively questions and sub-questions created by the SME and part of the SME template for assessing hidden or unconscious bias of a person. System user created “Decision Objects” are subject or topic areas for which a decision is to be made and preferably in the form of questions or statements to which the “Target,” who is the person or thing being evaluated, is to respond. System user created “Decision Dimensions” preferably are sub-questions relating to a Decision Object. These definitions of Profiles, Objects, a Dimensions will apply herein unless indicated to the contrary.

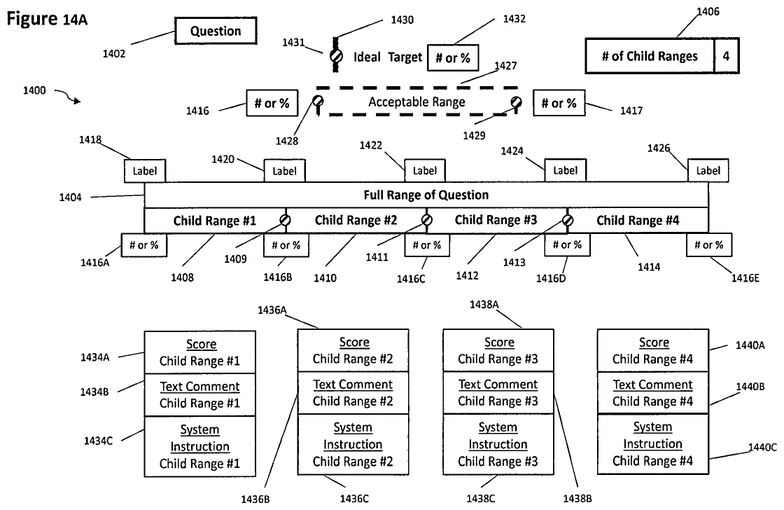

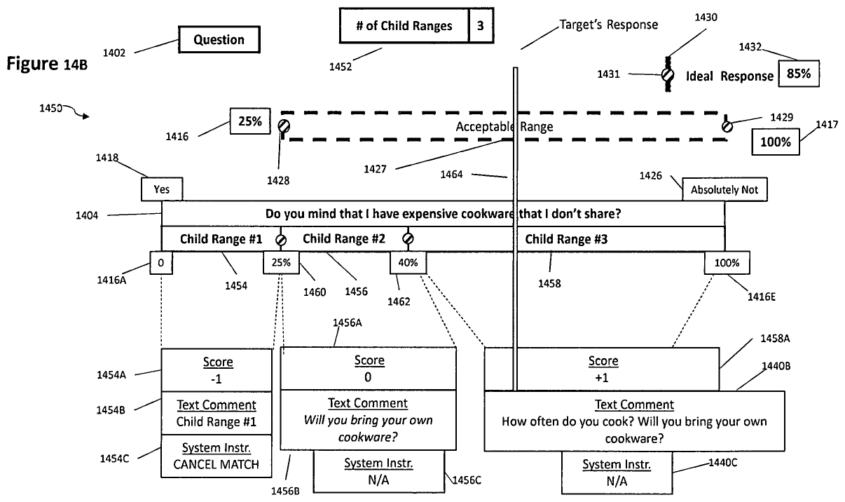

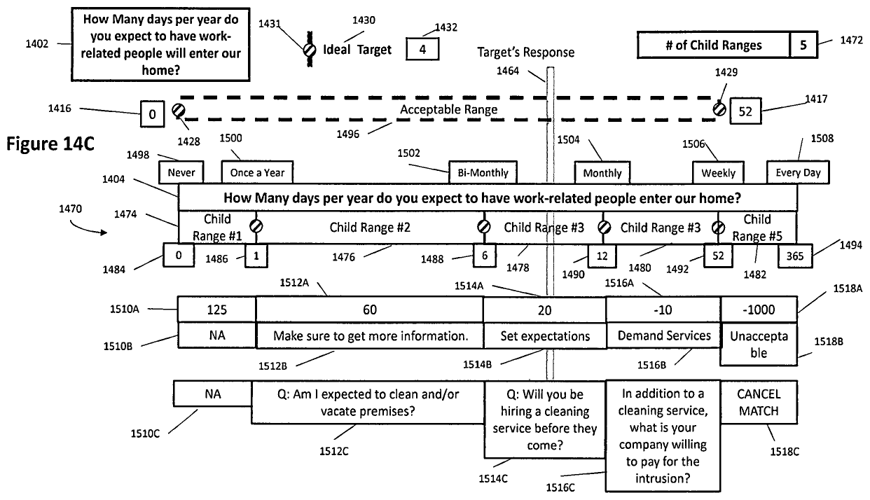

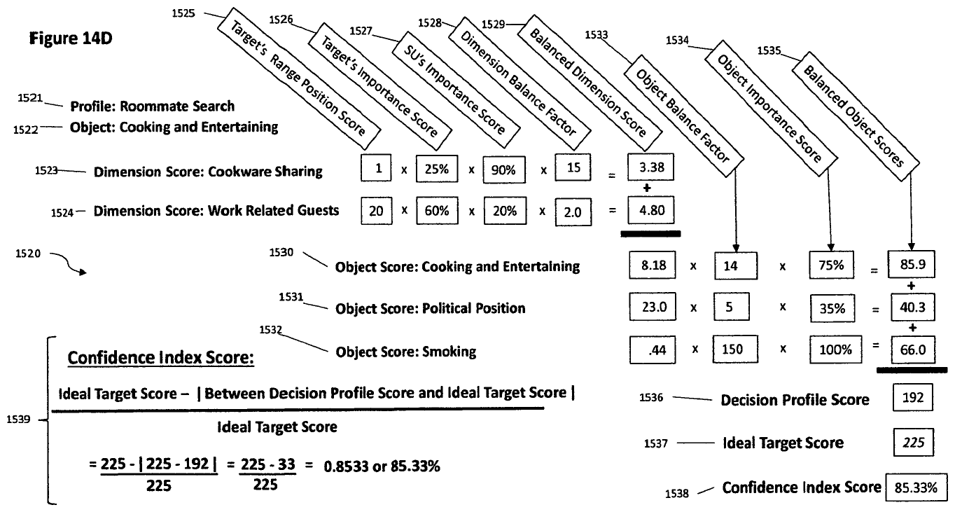

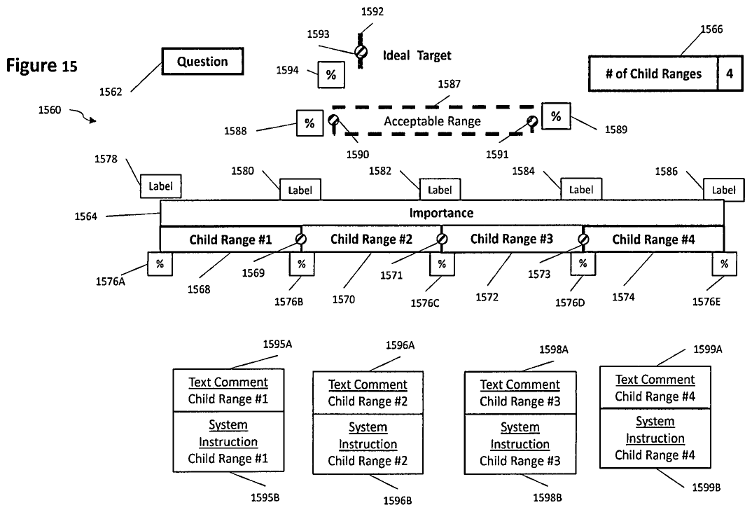

Before discussing the processes for bias assessment or decision-making, the method used to characterize Bias Dimensions and Decision Dimensions will be set forth because that is the basis for the generation of Bias Assessment and Confidence Index scores. Dimensions have two parts: (1) The “Question or Statement” created by the SME or system user to which a Target responds, and (2) the Importance Factor to which both the System User and Target assign a value. While the two parts are created using the same functionality, they serve dramatically different purposes. The Question or Statement frames the topic to which the Target provides answers, and the Importance Factor adds a second and complimentary data point by only focusing on the importance of the question or statement to the both the system user and target. The response values to the Question or Statement and Importance Factor are then combined as set forth to generate bias assessment or confidence index scores. The method for generating values from the Question or Statement responses will be described first with respect to FIGS. 14A-14C then the method for generating values for the Importance Factor will be described with respect to FIG. 15.

In carrying out scoring according to the present invention, the first action is the creation of a Profile question or statement, then the creation of questions or statements for the one or more Objects, then finally the creation of questions or statements for the one or more Dimensions for each Object. The actual scores are generated in the reverse direction. Preferably, the entity that creates the questions or statements with respect to Bias Assessment is a SME and with respect to decision-making is the system user or SME at the system user's behest.

As stated, the generation of scores begins with the Dimensions. The “target,” the person being evaluated for hidden or unconscious bias in the case of Bias Assessment or the party(ies) with whom the system user is engaged for decision-making, provides responses to the Dimension questions or statements that were sent to them in accordance with the system and method of the present invention. The Dimension scores are generated, and these scores are used to generate the Object scores, and in some cases, the Object scores are aggregated to generate a composite score for the Profile. The method of generating Dimension scores will now be disclosed.

Referring to FIG. 14A, generally at 1400, a representative Dimension template is shown. With respect to FIG. 14A, the Dimension “Question or Statement” (hereinafter collectively, “Question”) is shown at 1402. The full range for which the target can respond to the Question is shown at 1404. However, the full range may, but is not required to, be divided into a number of contiguous areas that are referred to as “Child Ranges.” As indicated at 1406, there are four Child Ranges chosen for this example. These are Child Range #1 at 1408, Child Range #2 at 1410, Child Range #3 at 1412, and Child Range #4 at 1414. The System user will set the limits for each child range and total breadth of the combined child ranges shall equal the full breadth of the full range. When this is done, it will mean that two contiguous child ranges will share a boundary limit. And the two child ranges at the ends of the full range will share a boundary limit with the full range at one side and one with a contiguous child range at the other. It is understood that a dummy child range may be used at occupy part of the range to ensure the full range is full as would be understood by a person of ordinary skill in the art.

The boundaries of a full range, and of any child range, may have labels to define their limits, including shared labels the contiguous child ranges or the coincident ends of a child range and the full range. These labels are shown at 1418, 1420, 1422, 1424, and 1426. Further, each boundary limit may be expressed as a number or percentage. This is shown in FIG. 14A at 1416A, 1416B, 1416C, 1416D, and 1416E. These numbers or percentages will apply to both the Child Ranges and the full range. Therefore, preferably each boundary limit for a child range or the full range will have either a label, a number/percentage, or both. And, if numbers are used with respect to the Child Ranges or the full range, they may be linear, logarithmic, or exponential. They may also be custom and span from negative to positive values. If percentages are used, it is not limited to just 100% for the full range. They may exceed 100% or be less than 0% and still be within the scope of the present invention.

In order to set the limits of the Child Ranges, each child range limit is enabled by the presence of an adjustment ball or slider at the boundary limit shared by two contiguous child ranges. In FIG. 14A sliders 1409, 1411, and 1413 are shown. Therefore, movement of a slider will result in one child range being increased in size while the other will be decreased.

Each Child Range will have associated with it a score, text comment, and system instruction. Of these three, it is always necessary to have a score assigned to each child range. This score is needed for calculating a bias assessment and confidence scores. Score ranges may be custom, linear, logarithmic or exponential.

Each child range may be assigned a text comment. These are triggered to assist system users with textual information about the details of a respondent's responses. And each child range, if selected, may result in a system instruction being triggered to cause an automated action to be taken by the system. An example of which may be to change or add Decision and/or Bias profiles, make a call to appropriate authorities to report dangerous potentialities, or to flag a target's profile.

Again, referring to FIG. 14A, with respect to Child Range #1, it has associated with it score 1434A, text comment 1434B, and system instruction 1434C. With respect to Child Range #2, it has associated with it score 1436A, text comment 1436B, and system instruction 1436C. With respect to Child Range #3, it has associated with it score 1438A, text comment 1438B, and system instruction 1438C. Last, with respect to Child Range #4, it has associated with it score 1440A, text comment 1440B, and system instruction 1440C.

At 1427 of FIG. 14A, it shows an “Acceptable Range.” This provided within the full range to indicate target responses that will not trigger other actions, such as, notify authorities of inappropriate behavior will potentially take place. Like child ranges, acceptable ranges will be defined by numbers or percentages at 1416 and 1417, and the range will be set by movement of sliders 1428 and 1429.

The system user may indicate along the full range a location that would be the ideal response it would prefer from a target. This is represented at 1430. The positioning of this location is made by slider 1431. And the number value or percentage of this ideal value is indicated at 1432. This is used for calculating the Confidence Index score.

To continue with an example of how Bias Assessment and Confidence Index scores are determined, the following is provided with respect to FIGS. 14B, 14C, and 14D. This method of determining scores will be incorporated in the description for both the bias assessment and decision-making processes.

Referring to FIG. 14B, the example generally shown at 1450 shows the population of the elements described with respect to FIG. 14A. With respect to FIG. 14B, the reference numbers for the same elements in FIG. 14A have the same reference numbers in FIG. 14B. Given this, the following tables are provided to show the population of the elements:

| Reference No. | Item | Value |
|---|---|---|
| 1402, 1404 | Question, Full Range | Do you mind that I have |
| | | expensive cookware that |
| | | I don't share |
| 1452 | # of Child Ranges | 3 |
| 1454, 1456, | Child Range #1, | N/A |
| 1458 | Child Range #2, | |
| | Child Range #3 | |
| 1430, 1431, | Ideal Response | 85% |
| 1432 | | |
| 1427 | Acceptable Range | 25%-100% |
| 1416, 1428 | Acceptable Range Lower | 25% |
| | Limit Slider Position | |
| 1417, 1429 | Acceptable Range Higher | 100% |
| | Limit Slider Position | |
| 1418 | Full Range Left | Yes |
| | Hand Label | |
| 1426 | Full Range Right | Absolutely Not |
| | Hand Label | |
| 1416A, 1460 | Child Range #1 | 0%-25% |
| | Boundary Limits | |
| 1460, 1462 | Child Range #2 | 25%-40% |
| | Boundary Limits | |
| 1462, 1416E | Child Range #3 | 40%-100% |
| | Boundary Limits | |
| 1464 | Target Response | 65% |
| 1454A, 1454B, | Child Range #1: | Score: −1 |
| 1454C | Score, Text Comment, | Text Comment: Child |
| | System Instruction | Range #1 |
| | | Sys. Instr.: CANCEL |
| | | MATCH |
| 1456A, 1456B, | Child Range #2: | Score: 0 |
| 1456C | Score, Text Comment, | Text Comment: Will you |
| | System Instruction | bring your own cookware? |
| | | Sys. Instr.: N/A |
| 1458A, 1458B, | Child Range #3: | Score: +1 |
| 1458C | Score, Text Comment, | Text Comment: How often |
| | System Instruction | do you cook? Will you |
| | | bring your own cookware? |
| | | Sys. Instr.: N/A |

The values and statements may be used to calculate, in this case, a Confidence Index score. However, it is be understood that this could also be used with different information populating the elements to be used for calculating a bias assessment score.

Referring to FIG. 14C, generally at 1470, a second example of populating the elements shown in FIG. 14A is shown. This Figure is provided to show the flexibility of the system and its adaptability for use in various types of situations. As shown with respect to FIG. 14C, a similar table is provided to show the values associated with the elements.:

| Reference No. | Item | Value |
|---|---|---|
| 1402, 1404 | Question, Full Range | How many days per year |
| | | do you expect to have |
| | | work-related people enter |
| | | our home? |
| 1472 | # of Child Ranges | 5 |
| 1474, 1476, | Child Range #1, | N/A |
| 1478, 1480, | Child Range #2, | |
| 1482 | Child Range #3, | |
| | Child Range #4, | |
| | Child Range #5 | |
| 1430, 1431, | Ideal Response | 4 |
| 1432 | | |
| 1496 | Acceptable Range | 0-52 |
| 1416, 1428 | Acceptable Range Lower | 0 |
| | Limit Slider Position | |
| 1417, 1429 | Acceptable Range Higher | 52 |
| | Limit Slider Position | |
| 1498, 1500, | Full Range Labels 0-365 | Never, Once a Year, Bi- |
| 1502, 1504, | | Monthly, Monthly, |
| 1506, 1508 | | Weekly, Everyday |
| 1484, 1486 | Child Range #1 | 0-1 |
| | Boundary Limits | |
| 1486, 1488 | Child Range #2 | 1-6 |
| | Boundary Limits | |
| 1488, 1490 | Child Range #3 | 6-12 |
| | Boundary Limits | |
| 1490, 1492 | Child Range #4 | 12-52 |
| | Boundary Limits | |
| 1492, 1494 | Child Range #5 | 52-365 |
| | Boundary Limits | |
| 1464 | Target Response | 20 |
| 1510A, 1510B, | Child Range #1: | Score: 125 |
| 1510C, | Score, Text Comment, | Text Comment: N/A |
| | System Instruction | Sys. Instr.: N/A |
| 1512A, 1512B, | Child Range #2: | Score: 60 |
| 1512C | Score, Text Comment, | Text Comment: Make |
| | System Instruction | sure to get more |
| | | information |
| | | Sys. Instr.: Q: Am I |
| | | expected to clean and/or |
| | | vacate premises? |
| 1514A, 1514B, | Child Range #3: | Score: 20 |
| 1514C | Score, Text Comment, | Text Comment: Set |
| | System Instruction | expectations |
| | | Sys. Instr.: Q: Will you be |
| | | hiring a cleaning service |
| | | before they come? |
| 1516A, 1516B, | Child Range #4: | Score: −10 |
| 1516C | Score, Text Comment, | Text Comment: Demand |
| | System Instruction | services |
| | | Sys. Instr.: Q: In addition |
| | | to a cleaning service, what |
| | | is your company willing to |
| | | pay for the intrusion? |
| 1518A, 1518B, | Child Range #3: | Score: −1000 |
| 1518C | Score, Text Comment, | Text Comment: |
| | System Instruction | Unacceptable |
| | | Sys. Instr.: CANCEL |
| | | MATCH |

As discussed previously, there are two elements for generating both bias assessment and confidence index scores. The two elements are the values generated relating to the responses to the Questions or statements, and the values generated relating to the responses to the importance factor. Having described the method for generating the values for the responses to the Questions or Statements, the method for generating the values for the Importance Factor will now be described referring to FIG. 15.

Referring to FIG. 15, generally at 1560, the method for generating values related to the Importance Factor will be described. To determine values for the importance factor, the representative template shown at 1560 has a number of the elements similar to the template shown in FIG. 14A, 14B, and 14C but it does differ. The template and differences will be set forth below.

With respect to FIG. 15, the Dimension “Question or Statement” (herein after collectively, “Question” unless otherwise indicated) is shown at 1562. The full range for which the target can respond to the Question is shown at 1564. However, the full range may, but is not required to, be divided Child Ranges. As indicated at 1566, there are four Child Ranges selected for this example. These are Child Range #1 at 1568, Child Range #2 at 1570, Child Range #3 at 1572, and Child Range #4 at 1574. The System user will set the limits for each child range and total breadth of the combined child ranges shall equal the full breadth of the full range. When this is done, it will mean that two contiguous child ranges will share a boundary limit. And the two child ranges at the ends of the full range will share a boundary limit with the full range at one side and one with a contiguous child range at the other. It is understood that a dummy child range may be used at occupy part of the range to ensure the full range is full as would be understood by a person of ordinary skill in the art.

The boundaries of the full range and the child range may have labels to define what the limit will be for the two contiguous child ranges or the coincident ends of a child range and the full range. These labels are shown at 1578, 1580, 1582, 1584, and 1586. Further, each boundary limit must be expressed as a percentage. In this Figure, the percentages are shown at 1576A, 1576B, 1576C, 1576D, and 1576E. These percentages will apply to both the Child Ranges and the full range. Each limit for a child range or the full range may have a label in addition to a percentage. Percentages must be 0% to 100% for the full range.

The Importance factor, like the Questions or Statements, has acceptable range 1587 with sliders 1590 and 1591, and upper and lower percentage ranges at 1588 and 1589, respectively. Further, the Importance Factor has an ideal target that is shown at 1592 and its percentage value is shown at 1594. The location of the system user's ideal target is controlled by slider 1593. The system user's location of the ideal target is used for generating the Importance Factor value based on the difference between the system user's importance factor value and that of the target.

In order to set the Child Ranges, it is enabled by the presence of an adjustment ball or slider at the boundary limit shared by two contiguous child ranges. In FIG. 15 sliders 1569, 1571, and 1573 are shown. Therefore, movement of a slider will result in one child range being increased in size while the other will be decreased.

Each Child Range may have associated with it a text comment and system instruction. A text comment is triggered to assist system users with textual information about the details of a respondent's responses. And each child range, if selected, may result in a system instruction being triggered to cause an automated action to be taken by the system. Again, referring to FIG. 15, with respect to Child Range #1, it has associated with it text comment 1595A and system instruction 1595B. With respect to child range #2, it has associated with it text comment 1596A and system instruction 1596B. With respect to child range #3, it has associated with text comment 1598A and system instruction 1598B. Last, with respect to Child Range #4, it has associated with it text comment 1599A and system instruction 1599B. The differences that should be noted, preferably, are, with respect to the Importance Factor, it is only based on percentages and not numbers, its full range is 0% to 100%, and there is not a score associated with it.

To continue with an example of how Bias Assessment and Confidence Index scores are determined, a description of what is shown in FIG. 14D will now be described. This method of determining scores will be incorporated in the description for both the bias assessment and decision-making processes.

Referring to FIG. 14D, generally at 1520, an embodiment of a method of the present invention to generate a confidence index score is shown. This method may be equally used for generating bias assessment scores. The Profile, Object, and Dimension system of the present invention supports multiple and varied types of scoring methods. Although two types of scoring have been described for purposes of disclosure, it would be understood by a person of ordinary skill in the art these are only examples and the present invention has the flexibility to use other scoring methods that use some or more of the disclosed elements set forth herein.

In FIG. 14D at 1521, 1522, 1523 and 1524, by way of example, it shows a Decision Profile, a Decision Object, and two Decision Dimensions associated with the Decision Object. With regard to Decision Dimension: “Cookware Sharing,” there are four values that are multiplied to generate the Balance Dimension Score for Decision dimension Cookware Sharing. These are the Target's Range Position Score 1525, 1; the Target's Importance Score 1526, 25%; the System User's Importance Score 1527, 90%; Dimension Balance Factor 1528, 15. The product of these values is Balance Dimension Score 1529, 3.38. Similarly, with respect to Decision dimension 1524: “Work Related Guests,” the Target's Range Position Score 1525, 20; the Target's Importance Score 1526, 60%; the System User's Importance Score 1527, 20%; Dimension Balance Factor 1528, 2. The product of these values is Balance Dimension Score 1529, 4.80. The products for the two Decision Dimensions are summed to generate Decision Object Score 1530 for the Decision Object 1522, “Cooking and Entertaining.” In FIG. 14D, two additional Object Scores are shown. One is Object Score 1531, “Political Position,” with a value of 23.0 and Object Score 1532, “Smoking,” with a value of 0.44.

Each of the Object Scores are multiplied by Object Balance Factor 1533 and Object Importance Factor 1534 two generate the Balance Object Score 1535. Namely, Object Score 1530 is derived from the product of 8.18×14×75% to generate a Balanced Object Score of 85.9; Object Score 1531 is derived from the product of 23.0×5×35% to generate a Balance Object Score of 40.3; and Object Score 1532 is derived from the product of 0.44×150×100% to generate a Balance Object score of 66. Then, these Balance Object Scores are summed to generate the Decision Profile Score 1536 which is shown as 192. To the extent there were more objects with respect to Decision profile 1521, “Roommate Search,” there will be additional dimension scores and object scores calculated to generate the Decision Profile score. This process will be described in greater detail subsequently.

Once Decision Profile Score 1536 is determined, it is used with the system user's ideal score to generate the Confidence Index Score. The method for generating the Confidence Index score with respect to the Decision Profile 1521 with Decision Object 1522 is shown at 1539. The absolute value between the Decision Profile Score and Ideal Target Score 1537 is subtracted from the Ideal Target Score. The resultant score is divided by the Ideal Target Score to generate the Confidence Index Score 1538.

As mentioned previously, two types of scoring have been disclosed according to the present invention. The scoring is applicable to the determination of the Confidence Index Score generated in FIG. 14D. The first type of scoring is percentage scoring and, if used, it must be applied across all Dimensions in a Decision Object. Percentage Scoring is based on a graphical assignment of the target's position indicator for each Decision Dimension question along their respective Full Range, which are from 0 to 100%. Percentage Scoring does not require Balancing Factors, which will be set to a value of 1. If the Target's Position Indicator lies within the system user's preferred range (which may overlap multiple Child Ranges along the Full Range), the distance from the target's position indicator to the closest Acceptable Range Limit is divided by the distance from the user's ideal position to the afore mentioned Acceptable Range Limit. The quotient is the first Decision Dimension score. If the system user permits or requires potential Targets to indicate their own Importance Scores, the Target's Importance score is multiplied by the first Decision Dimension Score and the product is the second Decision Dimension Score. If the system user has added a SU (System User) Dimension Importance Score, the second Dimension Score is multiplied by the SU Dimension Importance Score and the product is the third Dimension Score. The highest level (first, second, or third) Dimension Score is saved as the Dimension Score . If the Target's Position Indicator response is outside of the User's Acceptable Range, the Dimension Score is “0”. As mentioned earlier No Dimension Balancing Factors are used (i.e., set to “1”.)

The second type of scoring is referred to as “Custom Scoring.” The system user or a SME assigns custom scores to each Child Range to match their own specific needs. For example, consider that the system user has created an Object comprised of five Decision Dimensions. Since the scores may not be consistent from Dimension to Dimension, as they would be using percentage scoring, there is a need for a Balancing Factor for the scores of each Decision Dimension within a Decision Object, and for each Decision Object within a Decision Profile. In an example of a Decision Object with five Decision Dimensions, one Decision Dimension with a potential high score of 200 points must be balanced or normalized with another Decision Dimension that has a total score potential of 500 points by employing a Dimension Balancing Factor.

Decision Objects that use custom scoring also make use of an Object Balancing Factor. For example, if there are two equally important Decision Objects that have potentials of 200 points and 10 points, respectively. They also will need to be normalized.

Each Decision Object will also have an Object Importance Score that is indicated by the system user to be multiplied with the first Object Score to generate a Balanced Object Scores. The Sum of the Balanced Object Scores for a Decision Profile is the Profile Score.

Balancing Factors can be established through a manual or an automated regression process. Automated regressions have been widely applied and published on. And they are widely accepted mathematical and/or statistical normalization procedures and processes. As such, a person of ordinary skill in the art would understand how to use automated regressions. A visual score balancing tool, which graphically depicts the range of potential scores from either the Dimensions within an Object or the Objects within a Profile, it is part of the present invention. The Score Balancing tool will also permit a system user to manually apply an Object Importance Score to each Object. The system user has the ability to either manual or automated balancing for each Object, and for Object in a Profile. The Score Balancing Tool will reduce potential for unintended consequences of unbalanced scoring.

Now that the method of scoring has been described that will be used for both bias assessment scoring and decision-making scoring, the method system of the present invention will now be described.

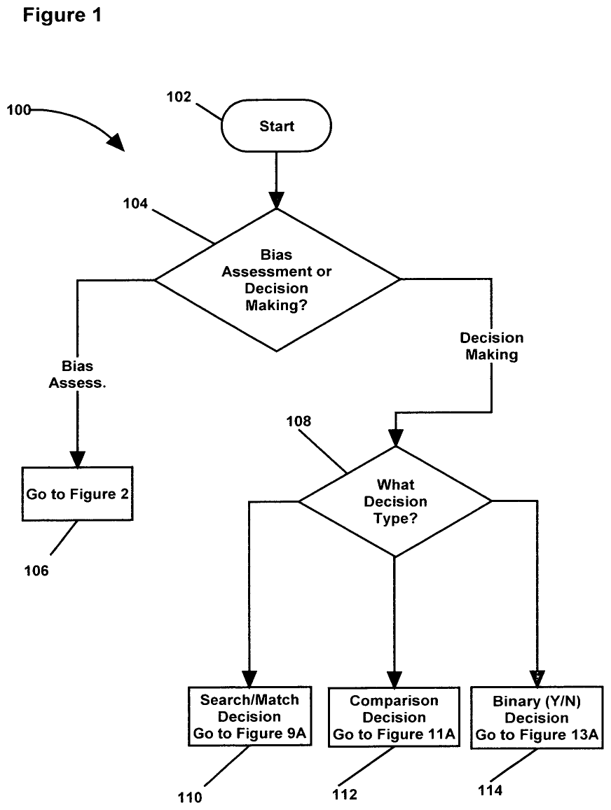

Referring to FIG. 1, generally at 100, a representative flow diagram of the initial actions taken by a system user according to the method of the present invention is shown. These actions according to the present invention will determine whether the system user is engaging in bias assessment or decision-making.

After the Start step at 102, the system user will decide what he/she/it wants to do with the decisioning tool at this time. The “entity” making the selection may be (1) an individual in his/her individual capacity (he/she) or an individual as a member of an Organization or (2) an Organization itself. For purposes of convenience, the “entity” will be referred to as the “system user” unless it is required to be more clearly defined as an individual or an Organization.

At decision step 104, the system user will choose whether to engage bias assessment on decision-making. If bias assessment is the choice, the process proceeds to process step 106, which will proceed with bias assessment. If at decision step 104, the system user chooses to engage decision-making, the process will proceed to decision step 108. At decision step 108, the system user will select which decision type with which to proceed. If the system user desires to pursue a searching/match decision, he/she will proceed to process step 110. If the choice is a comparison decision, the system user will proceed to process step 112. And finally, if the choice is a binary (Yes/No) decision, the system user will proceed to process step 114.

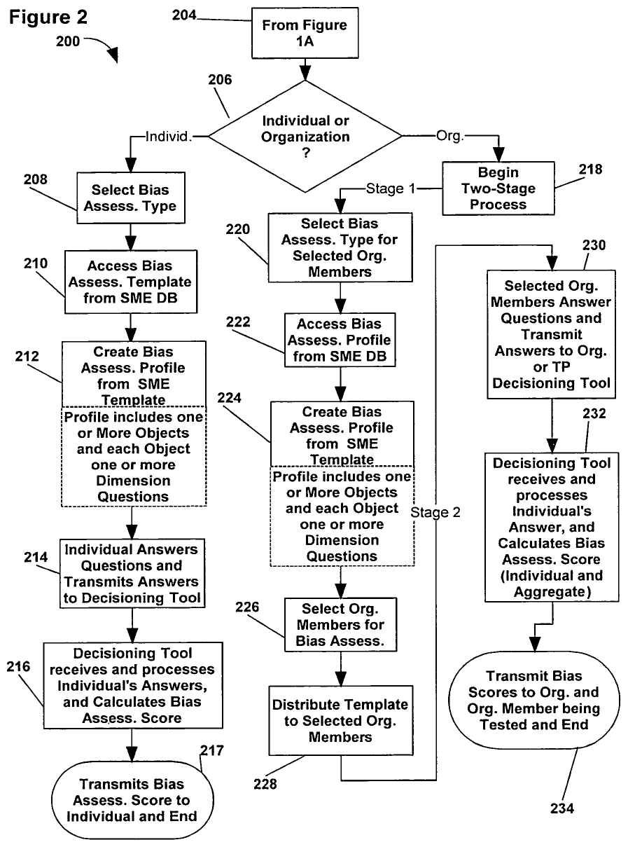

Assuming that the system user desires to conduct a bias assessment and proceeds to step 106, this step moves the process to step 204 in FIG. 2. FIG. 2, generally at 200, shows a representative flow diagram of a portion of the bias assessment method resulting in the generation of bias assessment scores for (1) an individual in his/her capacity as an individual or (2) a member of an Organization.

From step 204, the method progresses to decision step 206 where the system user must indicate whether he/she is an individual acting in their own capacity or an Organization. Taking first, where the system user is an individual acting in their own capacity, the method proceeds to step 208. At step 208, the system user will select the bias assessment type which he/she seeks to be tested to determine if he/she has hidden or unconscious bias with respect to the selected area. For example, the individual may seek to find if they have hidden or unconscious bias with respect to subject areas such as race, ethnicity, country of origin, gender, gender identity, types of food, areas of the country to live, transportation modes and vehicles, and education. This list is not exhaustive but is representative of subject areas that may be investigated for hidden or unconscious bias.

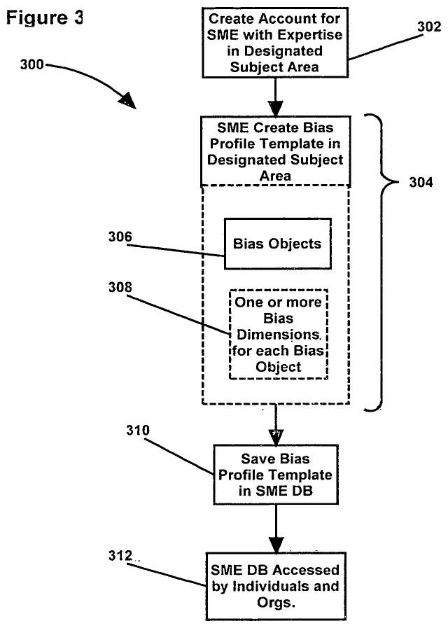

Once the subject area is selected, the system user will access a SME database that stores templates of questions for developing a Bias Profile for the system user. A SME who develops a template for a specific subject area is an expert in that field and knowledgeable of the current social norms associated with that subject area. SMEs are screened for their knowledge in the subject area to ensure each is a recognized expert. The method of onboarding a SME and the development of templates is set forth in FIG. 3.

FIG. 3, generally at 300, shows a representative flow diagram for a SME to develop a bias assessment template. Referring to step 302, an expert in a subject area seeking to become a SME for purposes of the present invention will be first screened for the level expertise and if they have the requisite qualifications, and an account will be created for that expert to develop, update, and deploy bias assessment templates in a searchable SME database.

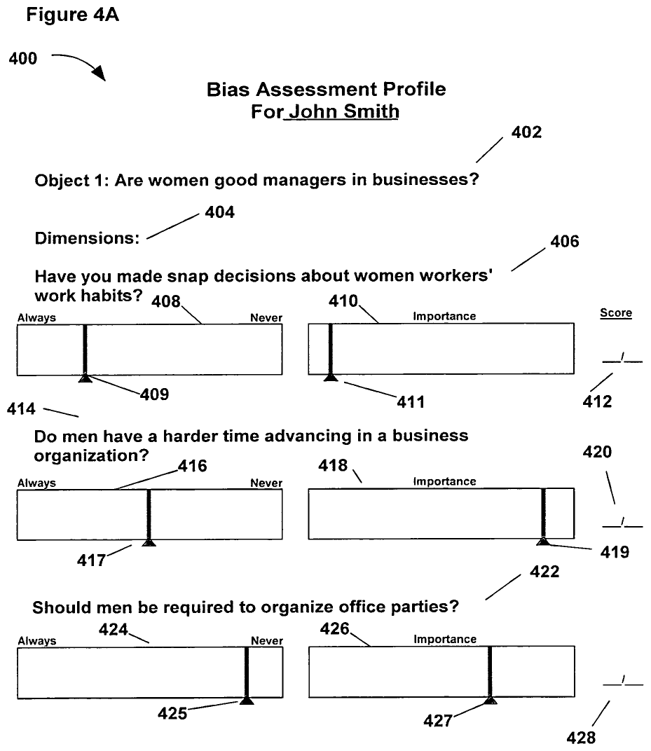

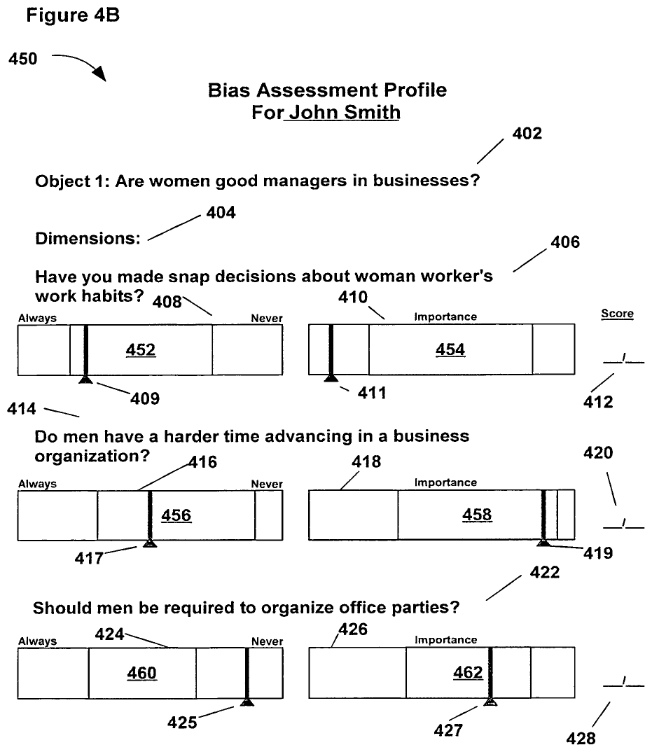

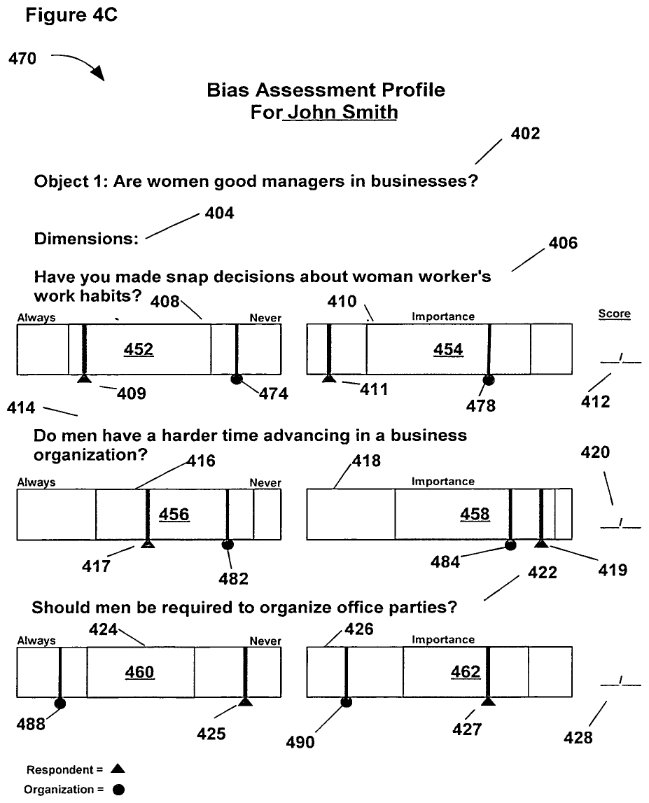

At step 304, a qualified SME will create a Bias Assessment Profile template for identifying hidden or unconscious bias that an individual may use when being tested in bias subject areas of the SME's expertise. This template will include one or more Bias Objects as shown at 306 and each Bias Object may include one or more Bias Dimensions at 308. An example of a Bias Profile template that include a Bias Object and associated Bias Dimensions questions is shown in FIG. 4A. FIG. 4A is representative of a Bias Profile to identify hidden or unconscious bias with respect to gender bias.

Referring to FIG. 4A, generally at 400, a SME bias assessment template for developing the Bias Profile for John Smith is shown. This Bias Profile consists of Object 1 at 402 and, in this representative case, three Bias Dimension questions are shown generally at 404. The Bias Object 1, “Are women good managers in businesses,” will be defined by the responses to the specific questions set forth in the Bias Dimensions at 406, 414, and 422. In FIG. 4A, the system user will record his/her responses to the Bias Dimension questions by moving vertical slider 409 in 408, vertical slider 411 in 410, vertical slider 417 in 416, vertical slider 419 in 418, vertical slider 425 in 424, and vertical slider 427 in 426 to the left or right from its initial location in answering the two-part question for the Bias Dimension. The first part is the system user's feeling as to the question itself and the second part is the importance of the question to the system user. Initially, preferably each vertical slider is located at a known location, such as, at the center , i.e., the 50% location. The system user can move the vertical slider to indicate his/her response from the central location. For example, with regard to bias Dimension question 406, the system user has placed slider 411 in 410 to indicate this in Bias Dimension question is of low importance to him/her. It would be understood by a person of ordinary skill in the art that the vertical sliders used for marking the system user scores in 408, 410, 416, 418, 424, and 426 may be replaced by other scoring methods, such as a numeric scale from 1-100, and still be within the scope of the present invention.

Taking first the Bias Dimension question at 406, the system user “John Smith” will be required to provide two responses. The first at 408 is in response to the posed question “Have you made snap decisions about women workers' work habits?” And, the second at 410 is the importance of the question to the system user. The responses of the system user with vertical slider 409 in 408 and vertical slider 411 in 410 will result in the two-part score at 412. This score will not be provided to the system user when initially answering the Bias Dimension questions but provided as part of the results. However, to explain these scores, the first indicates Profile Score for a specific Target and the second is the Confidence Index.

Referring to the second Bias Dimension question at 414, the system user responded with the positioning of vertical slider 417 in 416 and vertical slider 419 in 418, which reflects his/her feelings with regard to this Bias Dimension question. These responses will generate the scores at 420 once the responses are processed according to the present invention. Similarly, the system user's responses to the third Bias Dimension question at 422 in the positioning of vertical slider 425 in 424 and vertical slider 427 in 426 will generate the scores at 428 once the responses are processed according to the present invention.

Again, referring to FIG. 4A, the representative Bias Profile template at 400 is what is presented to the system user to obtain his/her responses. When the SME develops a Bias Profile template, the SME also provides an acceptable societal range for the part of the Bias Dimension question. If the system user's responses are outside of this range, it may be an indication of the system user's hidden or unconscious bias regarding the subject matter being investigated. If the responses fall within the range, it will be observed where within the range the response is located because as the vertical slider moves closer to either end of the range, it may indicate hidden or unconscious bias but not as severe as when the system user's response is outside the range.

Referring to FIG. 4B, generally at 450, the Bias Assessment Profile of John Smith in FIG. 4A is shown with the SME generated acceptable societal ranges shown for the parts of each Bias Dimension question. With regard to Bias Dimension question 406, it shows SME generated acceptable societal range 452. This range and the other ranges at 454, 456, 458, 460, and 462 have been developed and generated by the SME based on that SME's particular expertise in the subject area of the current bias assessment. In question part 408, vertical slider 409 is close to the left side of range 452 closer to the “Always” indication at the far-left side of the measurement scale for this question part. This may indicate that although the system user's response is within the acceptable societal range, there still may be evidence of some level of hidden or unconscious bias with respect to gender. In the second part of Bias Dimension question 406 at 410, the system user has placed vertical slider 411 at a scoring location outside of societal acceptable range 454 for the importance of this question. With the assumption that the left side of 410 is “0” and the right side is “100,” it would indicate that the system user would consider this Bias Dimension question of very little importance, which may indicate some level of gender bias on the part of the system user.

With regard to the other two Bias Dimension questions at 414 and 422, a similar analysis with respect to the system user's responses in relation to the SME acceptable societal ranges can be made. In question parts 416 and 418 of Bias Dimension Question 414, both of the system user's responses, namely, placement of vertical slider 417 in 416 and vertical slider 419 in 418, are within the SME societal acceptable ranges 456 and 458, respectively. However, the positioning of these system user responses within these SME ranges will be evaluated for purposes of determining to what extent they may indicate hidden or unconscious gender bias.

With regard to the Bias Dimension question at 422, the system user's response to the first part with the placement of vertical slider 425 in 424 of the question is far outside the SME acceptable societal range 460. This may likely indicate strong hidden or unconscious gender bias around this Bias Dimension question. The system user's response to the second part of last question 422 by the placement of vertical slider 427 in 426 is within the SME acceptable societal range but it will be analyzed to determine if it provides any indication of hidden or unconscious bias with regard to the importance of this question.

Referring to each of the Bias Dimension questions shown in FIG. 4B, namely at 406, 414, and 422, when the system user taking the test is provided with the results, the two-part scores at 412, 420, and 428 will be visible to system user. As indicated above, the two-part score represents ______ as the first score and ______ as a second score. The method for calculating the scores has been set forth above and incorporated here by reference. Profile Scores are listed in two numerical parts, plus comments and automated instructions undertaken: the first is the Profile Score for a specific Target and the second is the Confidence Index for that specific Profile Score.

Again, referring to FIG. 3, shown generally at 300, what is shown at step 304 has been described with respect to FIG. 4A. What is shown in FIG. 3 as the “Bias Object(s)” at 306 is represented by Object 1, “Our women good managers and businesses,” at 406 in FIG. 4A. Further, the “One or more Bias Dimensions for each Bias Object” at 308 in FIG. 3 is represented by Bias Dimensions at 404, namely Bias Dimension questions 406, 414, and 422, in FIG. 4A.

Once a SME-created Bias Profile is developed at step 304 in FIG. 3, this template is saved in a SME database at step 310. Once it is saved, individuals, like “John Smith,” or Organization members may access the SME database at step 312 to retrieve and use this or other templates following the format of what is shown in FIG. 4A for investigating potential gender bias in individuals or members of Organizations.

It would be understood by a person of ordinary skill in the art that a SME may be separately engaged to develop custom Bias Profile templates for use with the present invention. These custom templates may be provided to the system and method of the present invention for single or multiple use by system user or Organization having them developed. These custom Bias Profile templates will be fully compatible for use in the present invention for identifying hidden or unconscious bias.

Again, referring to FIG. 2, shown generally at 200, the system user at decision step 206 may alternatively select an “Organization” instead of an “Individual.” If that is the case, the method of the present invention will progress to step 218, which will begin a two-stage process for generating Bias Assessment scores that will be transmitted to both the Organization and individual being tested.

In the first step of the two-stage process, from step 218, begins at step 220 where the Organization will select the bias assessment type for the members of the Organization who are to be tested. By way of example, if the Organization was seeking to conduct the identification of hidden or unconscious gender bias, it may select a SME Bias Assessment Profile like the one shown in FIG. 4A. The Organization could also have a custom SME Bias Assessment Profile created that may be directed particularly to the circumstances and situations present at that particular Organization that would not be met with one of the SME Bias Assessment Profiles in the SME template database.

If at step 222 , the situation is not one in which the Organization is developing a custom Bias Assessment Profile, that Organization will access the SME database, and search for and select the appropriate bias profile template to use for testing, e.g., gender bias. Once this is done, the Organization at step 224 may edit the SME Bias Assessment Profile if it's needed to better identify hidden or unconscious bias in the selected subject area. When this is completed, the Bias Assessment Profile will include one or more Bias Objects and each Bias Object will include one or more Bias Dimension questions.

At step 226, the Organization will select certain of its members for the particular bias assessment testing commensurate with the Bias Assessment template that is either (1) directly from the SME database, (2) one from the SME database that has been edited by the Organization, or (3) a custom Bias Assessment Profile template. These members may be part of any group of the Organization. For example, the selected group could be members of the “C Suite,” a certain level of managers, forward facing members of the sales and marketing team, etc. or it could even be third-party vendors of the Organization. And, following this selection of the one or more members of the Organization being tested for hidden or unconscious bias, at step 228 the Organization will distribute the Bias Assessment Profile to the selected members. And this will end the first stage of this section of the method.

To track the distribution of the bias Assessment Profile templates and the receipt of the responses, the Organization, when distributing the Bias Assessment Profile, may notify the Organization member being tested of (1) the day and time it was sent to them, (2) the due date by which the responses need to be returned to the Organization, (3) when a reminder will be sent to the member, and (4) any penalty that may be imposed on the member if the responses are not returned by the due date. These four items are just examples and a person of ordinary skill in the art would understand more or less than this information may be provided to the Organization member and still be within the scope of the present invention.

The second stage begins at step 230 where the selected members of the Organization answer the Bias Dimension questions that are part of the Bias Assessment Profile and transmit these answers back to the Organization or a third-party hired by the Organization to process the responses in accordance with the present invention. The processing of each Bias Assessment profile template at step 232 will be the same as described with respect to FIGS. 4A and 4B. As such, those descriptions are incorporated herein by reference.

If there is a group of Organization members being tested for hidden or unconscious bias, there may be additional inputs from the Organization reflecting what it proposes the corporate response would be to the Bias Dimensions questions. More specifically, the Organization will position a vertical slider with respect to each Bias Dimension question part and these responses will be compared to the members response and its relationship to the SME acceptable societal range for that question part. Further, the results for each member being tested will be provided to the Organization along with an aggregation of (1) the members scores for each Bias Dimension question and (2) Bias Dimension scores for each Bias Object. And, finally, an overall composite score will be generated for the Bias Assessment Profile.

Before discussing the scoring mentioned immediately above, as stated, part of the Organization's review of the Bias Assessment Profile will include the Organization's belief where it would desire the member responses to be to the Bias Dimension questions. The representative placement of the vertical sliders by the Organization will be done without the Organization being privy to the SME acceptable societal ranges and without knowledge of the member answers. Given this, it may be found that the Organization itself has significant levels of hidden or unconscious bias with respect to a particular bias subject area.

Also, when the Bias Assessment Profile template is distributed to the members, the Organization's desired scoring through the placement of vertical sliders will not be visible to members being tested. Therefore, the only entity aware of the placement of the vertical sliders of the members taking the test, the Organization's placement of its vertical sliders, and the SME acceptable societal ranges will be the system of the present invention that will use these values in carrying out the method of the present invention to generate the Bias Assessment scores, and hidden or unconscious bias assessment analysis.

Referring to FIG. 4C, generally at 470, the Bias Assessment Profile for John Smith is shown with the Organization's desired responses from its members being tested. The system of the present invention will process the information shown in FIG. 4C to generate the scores for each of the Bias Dimension questions shown at 412, 420, and 428. Further, the system can generate not only individual scores for the people being tested, but also scores for the Organization for its levels of hidden or unconscious bias. The scores would be of the same type but separate from those shown at 412, 420, and 428.

Again, referring to FIG. 4C, with regard to Bias Dimension question 406, the Organization placed vertical slider 474 in 408 outside of SME acceptable societal range 452 closer to the “Never” end of 408. This may indicate levels of hidden or unconscious bias with respect to the organization. In 410, the Organization placed vertical slider 478 within the SME except acceptable societal range 454 and it will be evaluated based on that location. In second Bias Dimension question 414, the Organization's placement of vertical slider 482 in 416 and vertical slider 484 in 418 are both within the SME acceptable societal range for these question parts. Again, as before, the system and method of the present invention will evaluate these scoring positions. Finally, regarding Bias Dimension question 422, the Organization's placement of vertical slider 488 in 424 and vertical slider 490 in 426 are outside of the SME acceptable societal ranges. This may clearly indicate some strong levels of hidden or unconscious gender bias by the Organization with respect to the Bias Dimension question itself and the level of importance this question should have.

The previously described scoring method will be used for generating the bias assessment score. Accordingly, the previously described scoring method is incorporated here by reference.

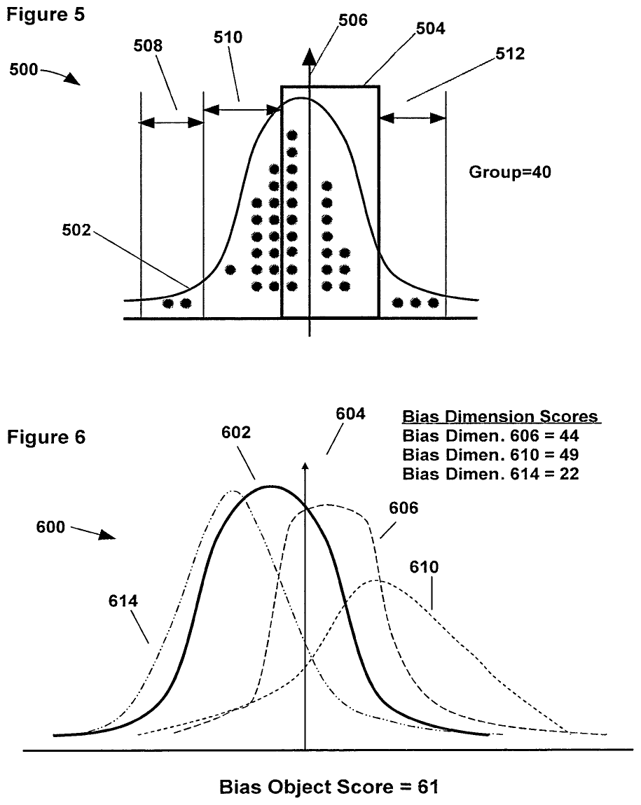

Referring to FIG. 5, generally at 500, a representative distribution of responses of a group of Organization members to a single Bias Dimension question is shown. Each of the small circles under the distribution curve represents an Organization member's responses to the Bias Dimension question at issue. There may be a distribution curve generated for each of the two parts of each Bias Dimension question. Also indicated, are possible outcomes an Organization may take where certain members of the Organization lie under the distribution curve.

Again, referring to FIG. 5, distribution curve 502 represents the distribution of the responses provided by each of a group of 40 (in this example) Organization members being tested relating to a particular Bias Dimension question. Each dot represents the value calculated based on the member's responses to the two parts of each Bias Dimension question, namely, the question itself and the importance the member assigns to the question. To add clarity to what is represented in FIG. 5, the responses shown by each dot underneath the distribution curve may represent the answers to Bias Dimension question 406, “Have you made snap decisions about women workers' work habits?” that is shown in FIG. 4A. The score for each member will be the value the member provides for the question itself that is weighted based on the importance value.

In FIG. 5, 504 represents an acceptable societal range for the responses that has been provided by a SME. At 506, the vertical arrow represents the Organization's desired target member response to the question. And, given these two factors, some of the possible outcomes with respect to remedial actions relating to the hidden or unconscious bias is the following. Starting first with the members with scores that fall within the SME-generated acceptable societal range and close to the Organization's target score, there would generally not be a need for any specialized remedial training with respect to hidden or unconscious bias in the area under testing but they may be members who would participate in general corporate training bias provided by the Organization.

In the area located at 508, there are two members in this outlying area. These member responses are far from the SME-generated acceptable societal range and target provided by the Organization. This may indicate hidden or unconscious bias at levels unacceptable for the Organization to keep these individuals employed there. As such, these individuals may be separated from the Organization because of the scores.

The members with scores in areas 510 and 512 are outside the SME-generated acceptable societal range 504, and away from the Organization's target value, which may indicate the necessity to provide them with specialized training to address their hidden or unconscious bias indicative of the scores that place them in these two areas.

Once the distribution curve is been generated for each of the Bias Dimensions associated with a particular Bias Object, a score is generated for the Bias Object based on the application of the Bias Dimensions. This will be described with reference to FIG. 6.

Referring to FIG. 6, generally at 600, a representative drawing for aggregating three Bias Dimension question distributions for generating and scoring a Bias Object distribution is shown. In FIGS. 4A, 4B, and 4C, there was a Bias Object question at 404, namely, “Are women good managers in businesses?” From that question, there were three Bias Dimension questions answered by the Organization members selected to participate. Each of the Bias Dimension questions will generate a distribution curve. Using the Bias Object question in FIGS. 4A, 4B, and 4C as an example of a Bias Object having three Bias Dimension questions associated with it, the same principles are used in FIG. 6 at 600 to form the Bias Object distribution that aggregates the three Bias Dimension distributions.

The first Bias Dimension distribution curve is shown at 606, the second Bias Dimension distribution curve is shown at 610, and the third Bias Dimension distribution curve is shown at 614. The three Bias Dimension distribution curves are normalized by the Organization's target value for the members associated with each distribution curve. By normalizing the three Bias Dimension distribution curves in this way, the Bias Object distribution curve representing all of the members' answers to the three Bias Dimension questions can effectively be shown by the aggregate Bias Object distribution curve 602. When the aggregate Bias Object distribution curve 602 is generated there, a SME acceptable societal range will also be created. This is generated by the SME based on his/her experience as an expert in the relevant subject area. A person of ordinary skill in the art would understand that the Bias Dimension distribution curves are only meant to be exemplary and combining these curves to generate the particular Bias Object distribution curve shown at 602 is also meant to be exemplary.

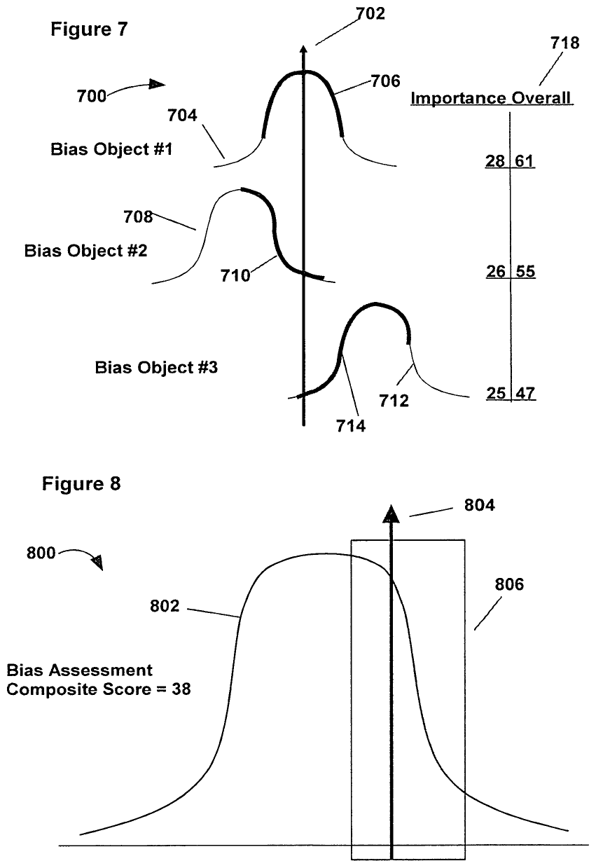

Next, to generate the composite score for the Bias Assessment Profile that has multiple Bias Objects, it will be necessary to combine the Bias Object distribution curves that have been generated from the Bias Dimensions responses as shown with respect to FIG. 6. Referring to FIG. 7, the method of combining multiple Bias Objects to produce distribution curves will be described.

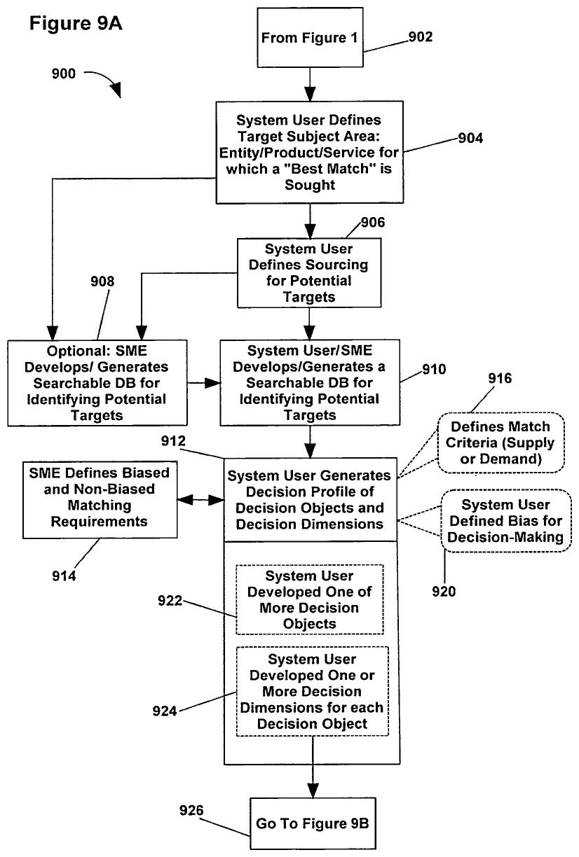

Similar to the aggregation of the Bias Dimension distribution curves described with respect to FIG. 6, combining the Bias Object distribution curves will be done by normalizing the situation curves based on the Organization's target response associated with each of these distribution curves. FIG. 7, generally at 700, shows three representative Bias Object distribution curves with their “Importance” scores and Bias Object scores shown. The priority weighting (importance) for each Bias Object distribution curve is used to generate a composite distribution curve and score for a Bias Assessment Profile subject area under investigation. A representative composite Bias Assessment distribution curve is shown in FIG. 8.

Referring to FIG. 7, Bias Object #1 is shown at 704, Bias Object #2 is shown at 708, and Bias Object #3 is shown at 712. In this Figure, the SME acceptable societal range is shown by the darkened part of the distribution curve. Specifically, regarding Bias Object #1, the SME acceptable societal range is shown at 706; Bias Object #2, the SME acceptable societal range is shown at 710; and Bias Object #3the SME acceptable societal range is shown at 714. Also referring to FIG. 7, the Importance score, which is used for ranking the Bias Objects, and the Overall score for each Bias Object is shown at 718. The Importance score is selected by the system user once the Bias Object distribution curves have been generated.

As stated, the three normalized Bias Object distribution curves are combined in a manner substantially the same as the method used to combine the Bias Dimension distribution curves. The resulting distribution curve is shown in FIG. 8, generally at 800. Referring to FIG. 8, the resulting composite Bias Assessment distribution curve is shown at 802. This distribution is formed normalized respect to the Organization's target value which is shown at 804. Further, there will be a SME-generated acceptable societal range for the composite Bias Assessment Profile. The composite score, which is shown in FIG. 8 as “38,” according to scoring method that has previously been described.

Having now described the method by which the decisioning tool of the present invention generates numeric scores for objectively identifying the hidden or unconscious bias of an individual, whether acting in his/her own capacity or as a member of an Organization, and providing Organizations with methods to aggregate information regarding the hidden and unconscious biases of its members to generate Organization-wide numeric scoring to understand its global hidden and unconscious bias exposure, the other novel feature of the decisioning tool of the present invention directed to decision-making will now be disclosed.

Referring to FIG. 1, at decision step 104, the system user may choose decision-making instead of bias assessment and be directed to decision step 108 of the method of the present invention where he/she will then have the opportunity to choose the decision-making type he/she desires to pursue: (1) searching/match decisions, (2) comparison decisions, or (3) binary (Yes/No) decisions. A novel feature of the present invention with regard each of the three decision-making types is an ability to focuses on “what” the system user wants with this computer-based system rather the system seeking to predict what he/she wants with respect to decisions. That is, the computer-based decision-making tool of the present invention places a higher priority on what the system user wants rather than the system seeking to predict what the system user wants with respect to a decision. To the extent that the system user is a member of an Organization, it permits the Organization to have its vision and mission to be part of decisions being made by its employees on its behalf. For example, an Organization may impress upon its employees making decisions to make them to meet its mission goal to promote methods to help address climate change and reduce its carbon footprint. And this can be done consistently with respect to all of the Organization's decisions.

To understand the decision types indicated above, they each will be separately covered beginning with searching/match decisions followed by comparison decisions, and last binary (Yes/No) decisions.

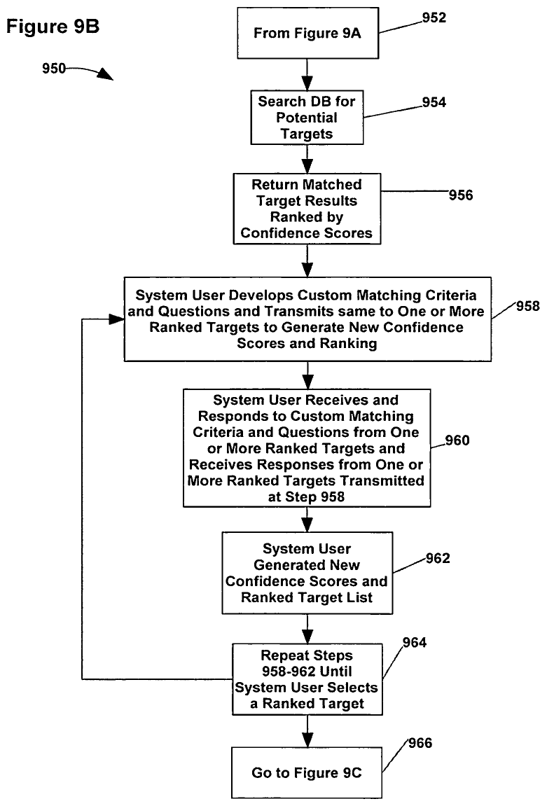

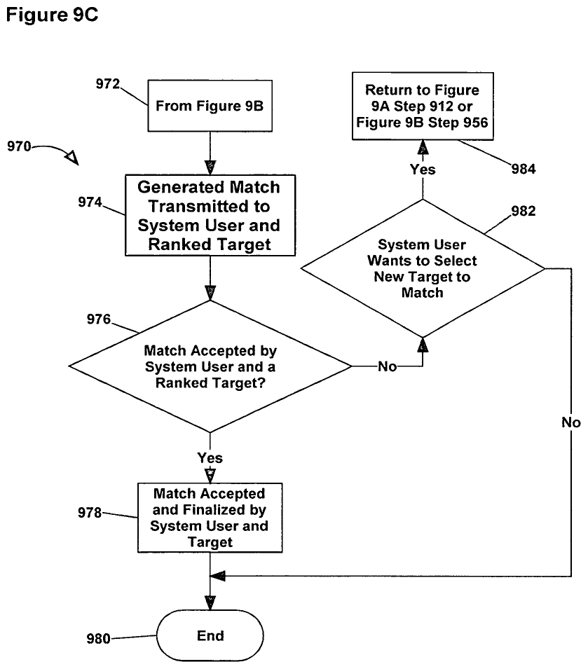

Referring to FIG. 1, if at decision step 108 the system user desires to engage in a searching/match decision, he/she will proceed to step 110. At this step, it indicates the method of the present invention continues at FIG. 9A. Referring to FIGS. 9A, 9B, and 9C, the steps of this searching/match decision-making method of the present invention are shown. Starting at FIG. 9A, generally at 900, at step 902, it indicates the process of the present invention is continued from FIG. 1 step 110. At step 904, the system user defines the target subject area for which a searching/match decision is to be made. The target subject area may be an entity, e.g., “Identifying a compatible college roommate;” a product, e.g., “an automobile;” or a service, e.g., “Tax preparation services.” In the selected target subject area, the system user may refine the area to one directed to a sub, micro, or macro area he/she wants to make a match decision

Once the system user defines the target subject area at step 904, he/she will progress to step 906 to define computer-based sourcing for potential targets. This will involve determining where the computer-based system can conduct searches to identify potential targets. Likely sources may be any of the top-tier Internet search engines such as Google, Bing, Yahoo, Contextual Web Search, to name a few. Also, the system user may have access to subscription-based services whose members may desire to have information about them in a searchable database for matches relating them, things they own, or services they provide.

Having identified sourcing for searching for potential targets, the system user will take that information and at step 910 develop then generate a searchable database for identifying potential targets. The information generated at steps 904 and 906 may optionally be provided by a SME at 908. The system user may do this if he/she desires the SME's assistance in developing the searchable database because of the SME's expertise in the target search area. This assistance may be in the form of the SME helping the system user with the development of the searchable database or it may be that the system user would engage the SME to create the searchable database for him/her.

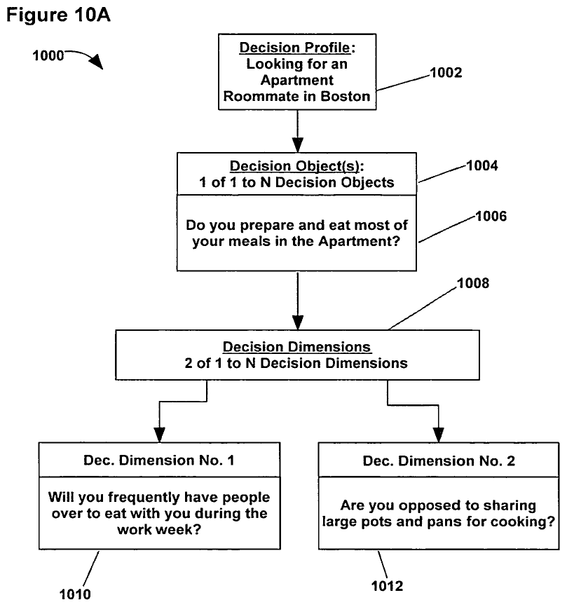

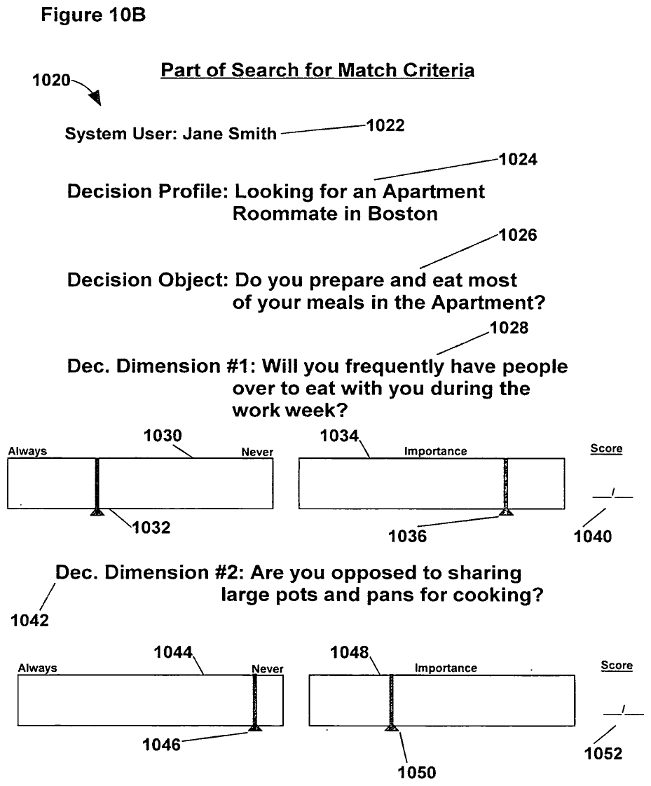

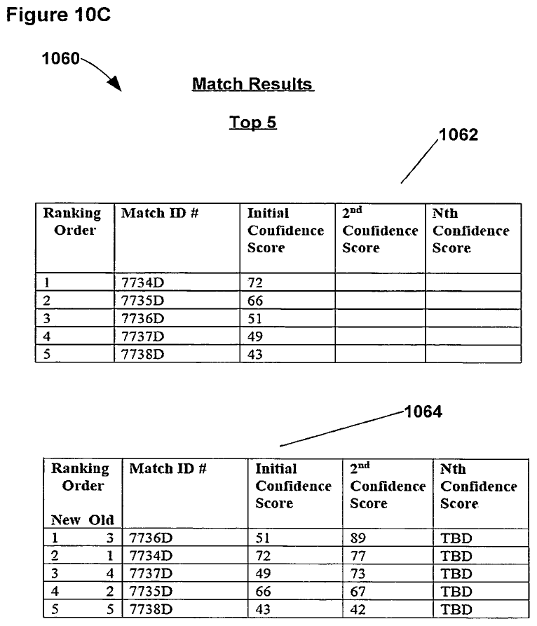

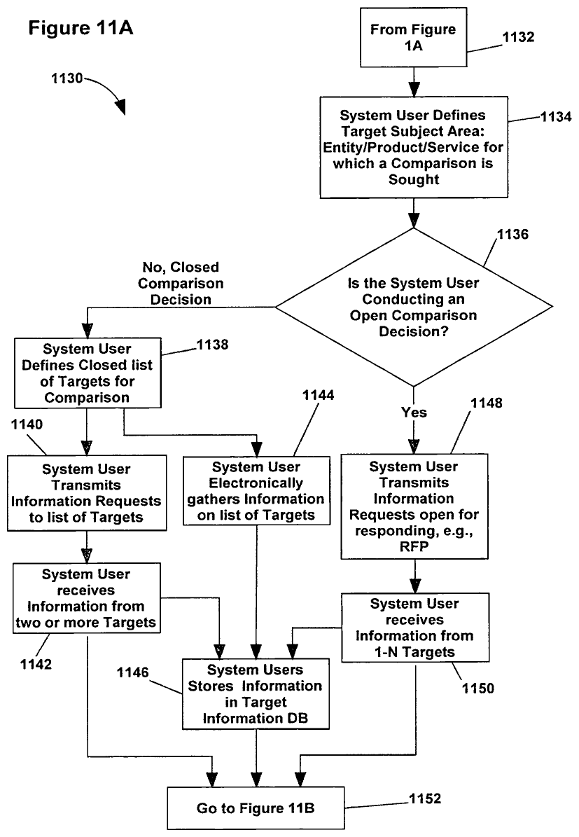

In order for the system user to conduct a search of the searchable database developed by the system user alone, with the help of a SME, or developed solely by a SME for the system user, he/she must develop a Decision Profile, one or more Decision Objects, and one or more Decision Dimensions for each Decision Object. This is generally shown in FIG. 9A at 912, 922, and 924. A representative Decision Profile, Decision Object, and two Decision Dimensions that may be developed by a system user is shown in FIGS. 10A-10D. The Decision Profile, Decision Object, and Decision Dimensions will define the matching criteria as set forth at 916, any defined bias the system user may have that will be part of the decision-making process, e.g., the system user in the context of looking for a roommate, may be biases against someone with a beard, which is shown at 920. This will also involve the system user developing the necessary keyword search and Boolean, Bayesian and other operators for conducting the searches for target matches. Additionally, in some contexts, a SME may assist in the system user in defining permitted biased matching requirements, e.g., not match with any targets who do not have people of color in any management positions, and non-bias matching requirements, e.g., targets who do not support local sports teams as shown at 914.

Referring to FIG. 10A, generally at 1000, a representative Decision Profile, Decision Object, and two Decision Dimensions for the Decision Object developed by a system user is shown. The search and match associated with FIGS. 10A-10D relate to matching roommates, it is understood that this is only representative and in no way restricts or limits the present invention to only this subject area.

In FIG. 10A at 1002, it shows the Decision Profile is directed to the system user “Looking for an Apartment Roommate in Boston.” So, what follows will be directed to developing decision requirements around this profile theme. Having established the Decision Profile subject area, at 1004, the system user will develop and generate from 1 to N Decision Objects. In FIG. 10A, only one of the 1 to N Decision Object is shown at 1006 and this object is “Do you prepare and eat most of your meals in the Apartment?” The lowest level of the inquiry structure according to the present invention is the Decision Dimensions. Like the Decision Objects' relationship with the Decision Profile subject matter, there can be 1-N Decision Dimensions for each Decision Object. At 1008, FIG. 10A shows the Decision Dimension level. In this example, there is Decision Dimension No. 1 at 1010 and Decision Dimension No. 2 at 1012.

Decision Dimension No. 1 at 1010 and Decision Dimension No. 2 at 1012 provide refinement to the Decision Object at 1004/1006. Decision Dimension No. 1 is “Will you frequently have people over to eat with you during the work week?” and Decision Dimension No. 2 is “Are you opposed to sharing large pots and pans for cooking?” are the requirements that will be scored along with the scoring of the importance of the Decision Object at 1004/1006. These and other Decision Object/Decision Dimension sets will be aggregated for each target under consideration to determine the best matching score for system user's matching requirements.

Referring to FIG. 10B, generally at 1020, the Decision Profile, Decision Object, and two Decision Dimensions in FIG. 10A with the representative scores for matching in the search conducted by a system user looking for best roommate match are shown. For purposes of description of the present invention, what is shown in FIG. 10B is a Decision Profile for a system user named James Smith as shown at 1022. At 1024, the Decision Profile is shown and at 1026 the Decision Object of the system user is shown. Next, Decision Dimension #1 is shown with the system user's preferred position and importance are shown for the Decision Dimension #1: “Will you frequently have people over to eat with you during the work week?” With regard to the Decision Dimension #1, in 1030, the slider 1032 is positioned at the system user's preferred response to the inquiry and tending toward the “Always” end of the response box. The system user's preferred response in the Importance scale 1034 is indicated by the position of slider 1036, which shows the importance of Decision Dimension #1 is high. For purposes of illustration, the slider positions in the preferred response to the Inquiry scale and the Importance scale could be associated with a numeric scale, such as from 1-100. If this is the case, the numeric score for the Inquiry scale, with “Never” end being “0” and the “Always” end being “100,” may be represented by “70.” Similarly, the importance score shown in Importance scale 1034, with the left end of the scale being “0” and the right end of the scale being “100,” may be represented by “80.” This would indicate a high level of importance of this question to the system user. What is shown at 1040 under “Score” is the score that would be represented by the degree a target identified in the search will match the system user's preferred responses to the Decision Dimension #1 inquiry and importance

Referring to Decision Dimension #2 shown at 1042, “Are you opposed to sharing large pots and pans for cooking?,” and using the same scoring method described with respect to Decision Dimension #1 relating to system user's preferred scores, in Inquiry scale 1044, the system user positioned slider 1046 at “15” indicating that system user did not mind sharing large pots and pans for cooking with the roommate. With regard to the Importance scale 1048, the system user positioned slider 1050 at “35” indicating that this of lower importance to the system user. Also, like what was described respect to the score at 1040 relating to Decision Dimension #1, the score at 1052 will be generated based on the match of a target's responses to those of the system user.

The positions that have been taken with respect to Decision Dimensions at 1028 and 1042 will be used in the previous described scoring method to generate a set of confidence index scores.

Referring to FIG. 10C, generally at 1060, a representative set of scores is shown for a search and match for target decision process. The scores are shown are for the “Top 5” matching scores of targets identified during the search. The cut off for identified targets in FIG. 10C is limited to the “Top 5,” however, the cutoff could be based on a score value or other means and still be within the scope of the present invention.

In FIG. 10C, there are two sets of rankings shown. The first set of rankings at 1062 is based on an initial calculation of Confidence Index Scores and the second is based on a second calculation of Confidence Index Scores after one or more supplemental questions have been submitted to one or more of the targets identified in the initial search. Again, referring to a set of scores shown at 1062, the system and method of the present invention will rank the identified target according to the scores generated based the target matching the system user's preferred scores relating to the Decision Dimensions. As shown, the scores range from 72 to 43. It is to be noted that for purposes of matching, the system of the present invention will generate anonymous match ID numbers for each of the ranked targets identified the search. This is done to provide anonymity between the system user and the identify target. To the extent any of the identified targets receive information by the system regarding a potential match, information about the system user will also be provided in an anonymous matter.

As indicated above, the new rankings shown in 1064 are based on one or more supplemental questions being searched with respect to one or more of the targets identified in the search. This information may be gathered by online searching or the transmission of the supplemental questions to an entity capable of providing the responses on behalf of the target. At 1064, it shows a second set of Confidence Index scores and a new set of rankings among the top five targets identified during the search. At 1064, it also shows that there can be “N” sets of questions that can be searched or sent to one or more of the targets to generate a different set of scores. Further, as will be explained subsequently, the identified target to extent they receive information from the system user, they can transmit questions to the system user to answer which may also affect the ultimate score generated for matching between any identified target and the system user. These questions will be in a format similar to what the system user is using for the supplemental questions to the one or more targets. It is also understood by a person of ordinary skill in the art is possible to use other formats for the supplemental questions as long as it can provide a mechanism to determine the extent to which a match in the two responses can be determined for scoring.

The new ranking of the Top five targets will be considered by the system user as to whether or not he/she the wants to complete a match starting with the top scoring target. However, the system user may choose to provide additional supplemental questions to one or more of the targets to determine to what degree that will cause a change in the scores and thereby the rankings of the best match for the system user. And as previously stated, the system user may respond to a question provided by one or more of the targets which may also change the rankings with respect to the best match for the system user.

Again, referring to FIG. 9A, after the actions at 912, the process proceeds to FIG. 9B as shown at 926. In FIG. 9B, shown generally at 950, it shows at 952 the process of FIG. 9A is continued. At 954, there is a search of the searchable database for potential targets. Then, at 956, matched targets are returned to the system user ranked by Confidence Index scores. The process proceeds to step 958 where it shows the development of the supplemental questions by the system user for transmission to one or more of the ranked targets and receives responses and generates new rankings based on those responses. At 960, the system user responds to any custom criteria or other questions from the one or more ranked targets and receives responses to the questions transmitted to the one or more ranked targets at 958. At 962, the system user generates new Confidence Index scores for the ranked Target list and based on the scores ranked the targets in a descending order with the highest score first. At 964, process steps 958-962 are repeated until the system user and ranked targets exhaust the transmission of supplemental questions between them. It is also to be noted that to the extent any of the ranked targets fails to respond to a supplemental question provided by the system user, this may detrimentally impact its ranking among the identified targets.

When all of the supplemental questions have been asked and responded to, the process proceeds to 966 which indicates the process will be continued with FIG. 9C. Referring to FIG. 9C, generally at 970, the remaining process steps of the searching/match decision process is shown. At 972, it indicates this process is continued from FIG. 9B. At step 974, the generated match is transmitted by the system to the system user and top ranked target. This transmission indicates that a match was found but the anonymity of the system user and match target is maintained. The process moves to decision step 976 where the system user and the system selected target must decide whether or not they accept the match. If the match is accepted, the process proceeds to step 978 and the system user and selected ranked Target disclose their identities and proceed to negotiate any deal they may desire with respect to the subject matter of the Decision Profile and the process moves to step 978 and the process ends. However, if, at 976, either the system user or the selected ranked Target does not want to accept the match, the process moves to decision step 982 where the system asked the system user whether he/she wants to attempt to still find a match. If the system user indicates “Yes,” and desires to (1) consider a whole new set of potential targets, the system will return the system user to step 912 in FIG. 9A or (2) seek a match with the next identify target in the ranked Target list, the system will return the system user to step 956 in FIG. 9B. If only other hand the system user desires to stop the process, he/she will go to end step 980, ending the searching/match decision process.

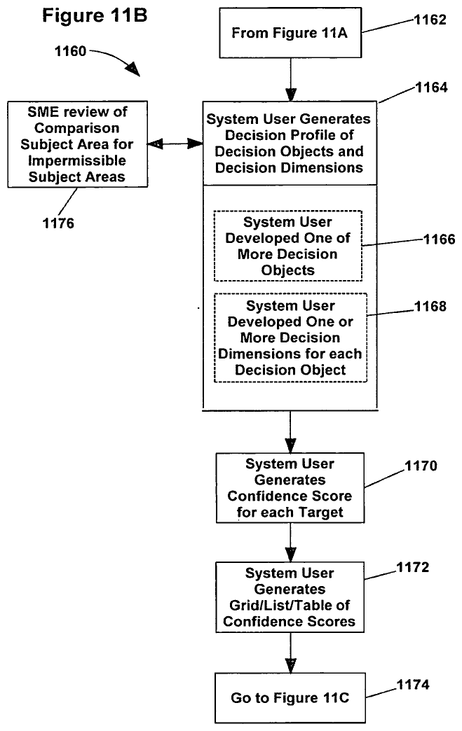

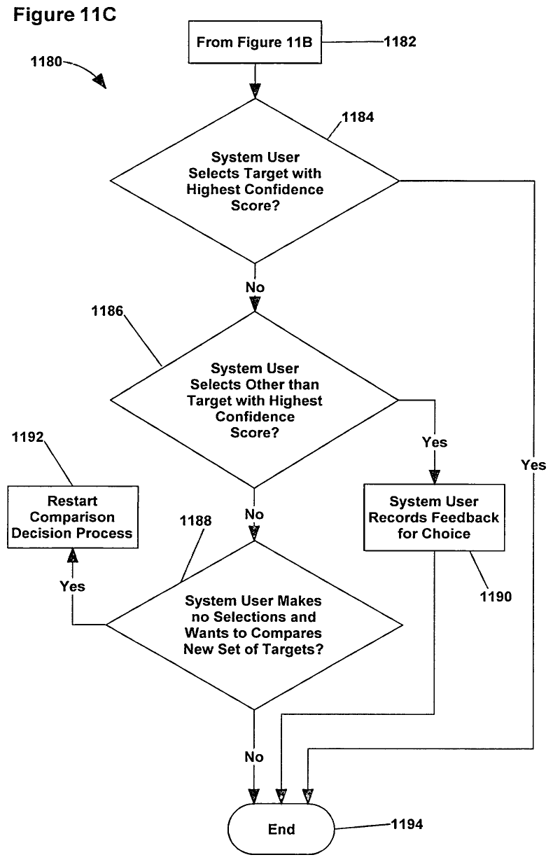

Having described the searching/match decision process, the comparison decision process will now be described. Referring to FIG. 1, at decision step 108, the system user wishing to make a comparison decision will move to step 112 which indicates the system user should go to the comparison decision process beginning at FIG. 11A.

Generally, when a system user is considering making comparison decisions using the process of the present invention, there are two comparison decision types from which to choose. The first is a “closed comparison” decision in which only a predetermined list of targets are permitted to complete the information requested by the system user. The second is an “open comparison” decision in which any number of third-party users of the system may complete the information requested by the system user, e.g., a generally open request for proposal (RFP).

FIG. 11A, generally at 1130, shows the beginning of the comparison decision process according to the present invention. At 1132, it indicates that the process is being continued from what is disclosed in FIG. 1. At process step 1134, the system user will define the target subject area on which the comparison decision will be focused.

This target subject area may be directed to an entity (in the form of a person or company), a product (type of automobile to purchase), or a service (telephone services). A person of ordinary skill in the art would understand that there may be other target subject areas than the three that have been indicated above and it would still be within the scope of the present invention.

After the system user defines the target subject area at step 1134, the process moves to decision step 1136 where the system user will decide whether he wants to conduct a closed comparison decision or an open comparison decision. If the system user selects an open comparison decision, you will move to process step 1148 where there will be the transmission of information requests that will be open for responding from anyone authorized to be on the decision-making system. Alternatively, the transmission of the information requests may be open to others outside of the decision-making system, for example, it can be posted on industry electronic boards or other types of media available to large numbers of people or companies. An example of such posting locations would be any that could be used for posting request for proposals (RFPs) to attract people or companies in a specific subject area.

After the system user post information requests, preferably in a designated format, at the appropriate locations, which may be electronic or otherwise, at process step 1150, the system user will receive the requested information from 1-N targets in the preferred format. The information that is received will be stored in target information database 1146. At this point, the system user will move to 1152, which indicates the system user will proceed with further processing of the comparison decision method according to the present invention found at FIG. 11B.

Returning to decision step 1136, if the system user decides that he/she wants to conduct a closed comparison decision, the process will move to process step 1138. At this step, the system user will define the closed list of targets for which a comparison decision is sought. Once the target list for comparison is generated by the system user, the system user will transmit the information requests to these targets and, preferably, the information requests will be in a standardized format. Alternatively, at process step 1144, the system user may obtain through the Internet or other electronic searching means the needed information about the targets so that the comparison decision process can be performed. Electronic searches of this type may be done by the system user or by a third-party hired by the system user.

At process step 1142, the system user receives the requested information back from two or more targets. This information is stored in target information database 1146. Also, the information electronically obtained by the system user or his/her surrogate at process step 1144 is stored in target information database 1146. The accumulated information about the targets is transmitted to step 1152 which indicates the comparison decision process will be continued on FIG. 11B. This is necessary so that the system user can access the target information for carrying out the necessary actions to reach a comparison decision.

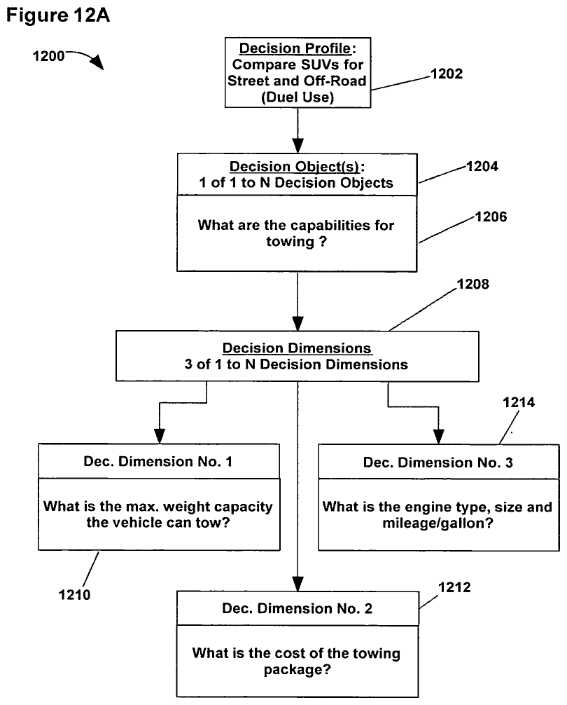

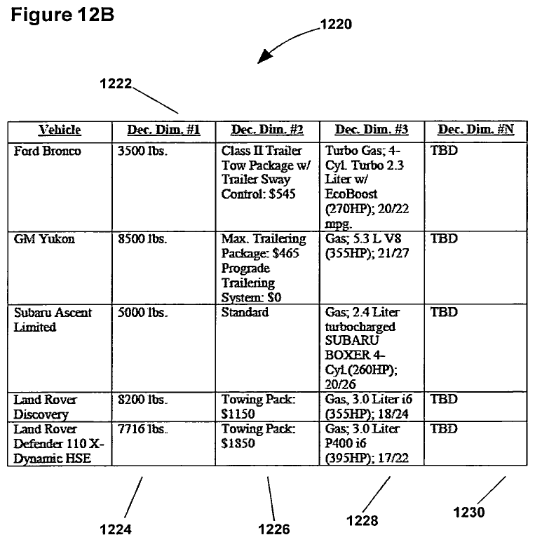

Referring to FIG. 11B, generally at 1160, a continuation of the comparison decision process from FIG. 11A is indicated at step 1162. Given the system user has obtained the necessary comparison information that is now stored in the target information database, at process step 1164, the system user will now generate a Decision Profile that includes Decision Objects and Decision Dimensions for scoring each of the targets that are part of the comparison decision process. As shown in FIG. 11B, the system user will generate one or more Decision Objects as shown at 1166 and then generate one or more Decision Dimensions for each Decision Object generated at 1166. An example of a Decision Profile, Decision Object, and three Decision Dimensions is shown in FIG. 12A.

Referring to FIG. 12A, generally at 1200, a representative Decision Profile, Decision Object, and three Decision Dimensions for the Decision Object are shown. At 1202, it shows the Decision Profile system user for which Decision Objects and Decision Dimensions will be built. For purposes of illustration, at 1204, it shows that there may be from 1 to N associated with the Decision Profile “Compare SUVs for Street and Off-Road (Dual Use).” A representative Decision Object relating to the Decision Profile is shown at 1206, which is “What are the capabilities for towing?” In this example, it indicates at 1208 that there are three of the 1 to N Decision Dimensions shown. The first is Decision Dimension #1 at 1210, which is “What is the max. weight capacity the vehicle can tow?”; The second is Decision Dimension #2 at 1212, which is “What is the cost of the towing package?” and the third is Decision Dimension #3 at 1212, which is “What is the engine type, size, and miles/gallon?”.

FIG. 12B, generally at 1180, shows information relating to the Decision Object shown in FIG. 12A with regard to five vehicles being compared that has permission stored in According to the process of the present invention, three Decision Dimensions will be scored, their scores will then be used to generate an aggregate Decision Object Confidence Index score and the plurality of Decision Object scores will be combined to provide the SUV with the highest score based on the Decision Profile criteria developed by the system user. This will be described in more detail and the current descriptions relating to FIGS. 11B and 11C.

Again, referring to FIG. 11B at step 1164, it is noted that at 1176 there is review of the comparison target subject area by an SME to determine if it is a permissible subject area for comparison. For example, if the comparison is to determine which local convenience stores are easier to rob, then the system of the present invention will not proceed any further and the process will be ended.

After the system user generates the Decision Profile, the 1-N Decision Objects, and the 1-N Decision Dimensions for each Decision Object as shown at 1164, 1166, and 1168, the process moves to process step 1170. At this step, the system user generates comparison scores for each of the targets that are part of the comparison decision. FIG. 12B, generally at 1220, shows a portion of information that may have been stored in, and retrieved from, target information DB 1146 (FIG. 11A). As shown at 1222, this information relates to five target vehicles being compared. More specifically, it relates to information used to respond to the three Decision Dimensions in FIG. 12A. The information at 1224 relates to Decision Dimension No. 1, the information at 1226 relates to Decision Dimension No. 2, and the information at 1228 relates to Decision Dimension No. 3. The information at 1230 represents information that would apply to any of the additional “N” Decision Dimensions.

As stated, the scores for Decision Dimension will be calculated at step 1170. The method for calculating these scores is according to the method that has been described. This scoring method is consistent with the scoring method used in the searching/match decision method.

After the scores are generated for the each of the targets, at process step 1172, the system user generates a grid, list, table, or other means that shows the highest to the lowest score for all of the targets that were compared. List that is generated may select maybe the top three or four further consideration. Once the list is generated, the system user will proceed to 1174 where it indicates the process will continue on FIG. 11C.

FIG. 11C, generally at 1180, shows the remainder of the comparison decision process on the present invention. Referring to 1182, it indicates that this Figure is a continuation from what is shown in FIG. 11B. The first step shown in FIG. 11C is decision step 1184. At this step, the system user decides whether to select the target with the highest comparison score, i.e., the highest Confidence Index score. If the system user does select the target with the highest score, the process will proceed to terminal step 1194 to end the process. At this point, the system user will contact the selected target and negotiate whatever activity, contract, or other relationship the system user wants to have with the target.

If for some reason the system user does not want to select the Target with the highest Confidence Index score or desires to look at a new set of targets, the system user will proceed to decision step 1186. At this step, the system user may select any of the other targets that were evaluated in the comparison process regardless of their Confidence Index score. Preferably, if the system user makes one of the selections, the process will proceed to process step 1190 where the system user may optionally provide feedback to the system of why this alternative choice was made. After this the process proceeds to terminal step 1194 to end the process.

If the system user does not select any of the targets that were compared in the current set of targets, the system user will proceed to decision step 1188 where he/she will decide if it is desirable to restart the comparison decision process with a new set of targets. If the system user decides that is desired, the process will move to process step 1192 for restarting the comparison decision process. As such, the system user will be returned to the beginning of the process at step 1134 in FIG. 11A. Alternatively, if at decision step 1188, the system user decides he/she does not want to engage a new set of targets, the process will proceed to terminal step 1194 and end the process.

Having described the comparison decision processes present invention, the third type of decision process, the binary (Yes/No) decision process, will be described. The binary (Yes/No) decision process is a subset of the comparison decision process has been previously described. However, for clarity, the flow diagram for this third decision process of the present invention will now be set forth.

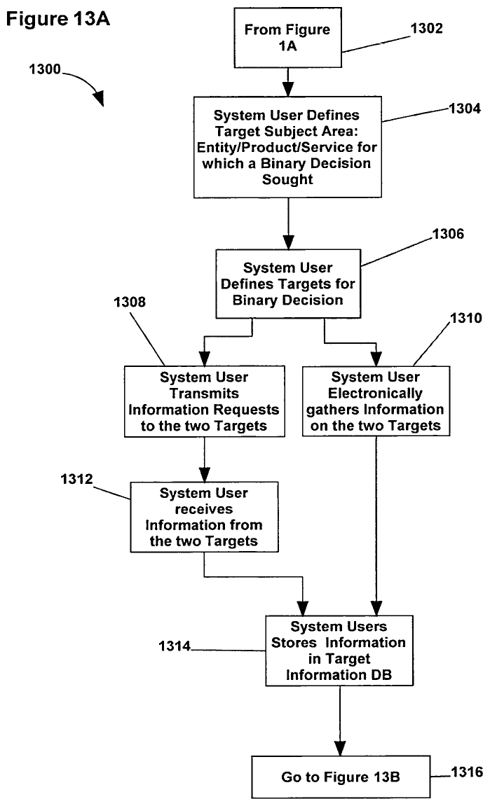

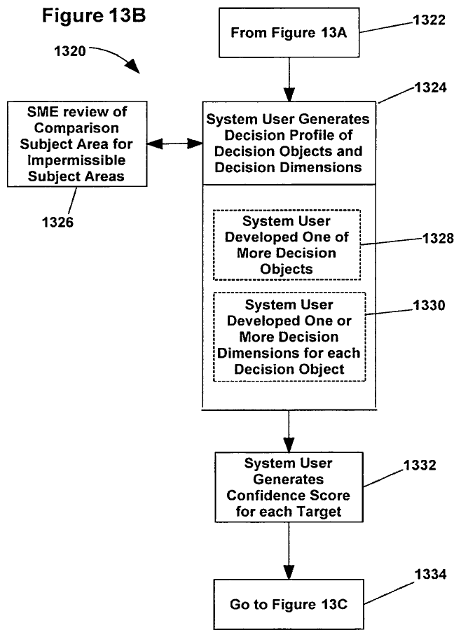

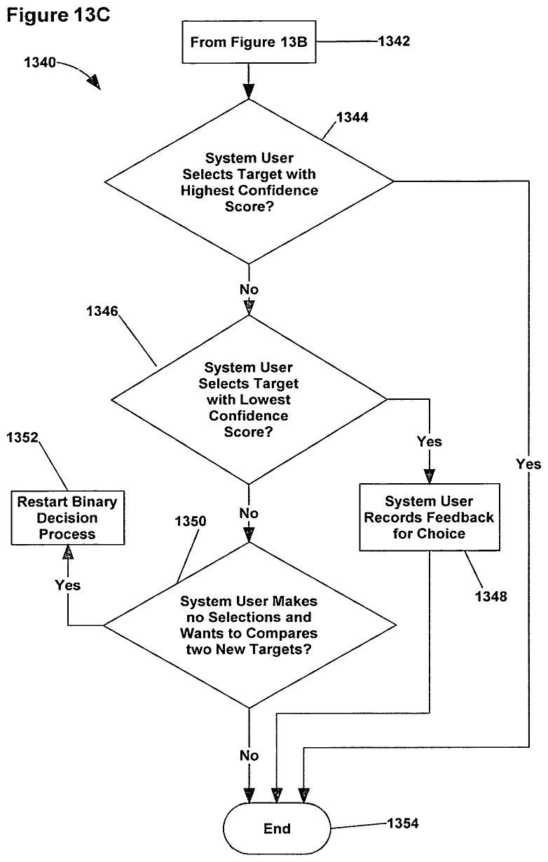

Referring to FIG. 1 at decision step 108, if a system user decides to carry out a binary (Yes/No) decision, the process will move to 114 which indicates the process will continue on FIG. 13A. Referring to FIG. 13A, generally at 1300, a first portion of the process for carrying out a binary (Yes/No) decision is shown. At 1302 of FIG. 13A, it indicates that the process that follows continues from FIG. 1. At process step 1304, the system user will define the target subject area for the binary decision in substantially the same way was carried out with respect to comparison decision process step 1134 in FIG. 11A, and, as such, that those descriptions are included here by reference. After defining the target subject area, the process moves to process step 1306 where the system user will define the two targets for the binary decision. For example, if the system user was seeking the decide whether his/her company should purchase a certain machine, one target would be “Yes” to make the purchase and the other target would be “No” not to make the purchase. This is just one example and a person of ordinary skill in the art would understand that there are others and will still be within the scope of the present invention.

After the two targets have been defined, it is now necessary to obtain information about the two targets. According to the present invention, there can be two methods to obtain this information. At process step 1308, the system user may send out information requests to the targets if such targets had the ability to appropriately respond. Further, it may be that the system user may send out such requests to only one of the two targets depending on who or what the targets are. The other method of obtaining information regarding the two targets is shown at process step 1310. At this step, the system user gathered information about one or both targets via electronic means, such as, researching information on for example the Internet. Again, this may apply to one or both targets.

If the system user has found it appropriate to send information requests to one or both targets, at step 1312, the system user will receive the requested information back from the one or both targets. The information that is received at process step 1312 and the information electronically gathered by the system user at process step 1310 are input to a target information database at 1314 to be accessible by the system user during the process. After the information is loaded into the target information database, as indicated at 1316, the process will continue at FIG. 13B.

FIG. 13B, generally at 1320, it shows the continuation of binary decision process from FIG. 13A. This is represented at 1322. At process step 1324, the system user generates a Decision Profile, Decision Objects and Decision Dimensions for the two targets. It is noted at 1328 the system user will develop one or more Decision Objects for the Decision Profile. Then at 1330, the system user will develop one or more Decision Dimensions for each Decision Object. The methods of developing the Decision Objects and Decision Dimensions are substantially the same as the method for developing Decision Objects and Decision Dimensions with respect to the comparison decision process. This is set forth with respect to FIG. 11B at 1164, 1166, and 1168, and FIGS. 12A and 12B. Those descriptions are incorporated here by reference.

Further, as shown at 1326, there will be a SME review of the target subject area to ensure that it is a permissible subject area. As set forth respect to the comparison decision process, if it is impermissible it may result in ending the process.

Based on the responses to the Decision Dimensions a Confidence Index score for each target will be generated. This is set forth at process step 1332. The method of generating the Confidence Index scores for each of the targets is effected the same as the method described for the comparison decision process. Therefore, those descriptions are incorporated here by reference.

After the Confidence Index scores have been generated for each target, as shown at 1334, the remainder of the bias decision process is continued on FIG. 13C. Referring to FIG. 13C, generally at 1340, the remainder of the bias decision process is shown. As indicated at 1342, this process is continued from FIG. 13B. At decision step 1344, the system user decides whether to select the target that has the highest Confidence Index score. If the system does do that, the process will move to terminal step 1354 and it will end. At this point, the system user will take the necessary actions for effecting the desire relationship with that target. If the system user decides not to select the target with the highest Confidence Index score, the process moves to decision step 1346. Here, the system user decides whether to select the target with the lowest Confidence Index score. If the system user does, the process moves to step 1348 where the system user will record reasons for the selection of the target with the lowest score rather than the target with the highest score. After doing so, the process moves to terminal step 1354 to end the process. After this, the system user will take such actions as establish a relationship with the target with the lowest Confidence Index score.

If the system user at decision block 1346 decides not to select the target with the lowest Confidence Index score, the system proceeds to decision block 1350 where the system user decides whether to end the process or restart the binary decision process. If the system user decides to no longer engage in the binary decision process, you she will proceed to terminal step 1354 and end the process. On the other hand, if the system user decides to restart the binary process with new targets the process will proceed to process block 1352 which will restart the process beginning at process step 1304 in FIG. 13A.

With respect to both the comparison decision process and binary decision process, there will be anonymity between the system user and the target to the extent that target is an entity such as a person, corporation, institution, etc. until such time as both parties agree to the match. It is only at this time that the two parties will have their identities disclosed to the other. This process is the same as described with respect to the searching/match decision process and therefore that disclosure is included here by reference.

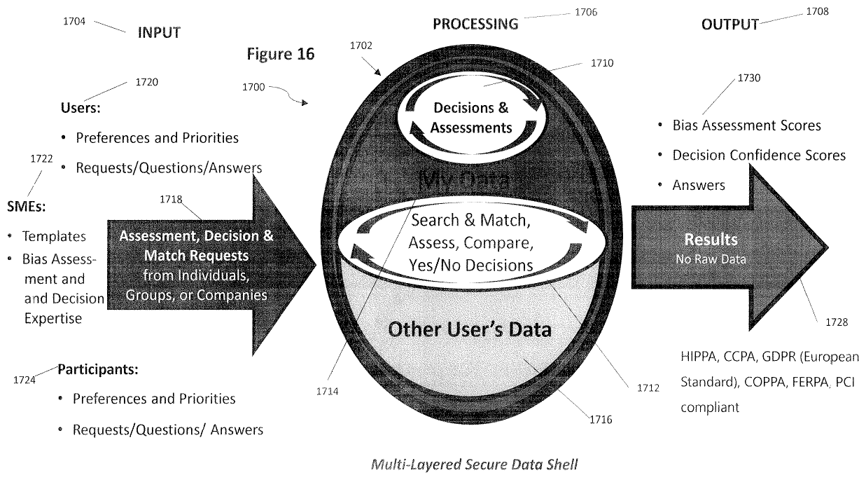

The system and method of the present invention also provides a secure environment for the handling of information that is processed. Given the information being processed includes, but is not limited to, bias assessment information, personal data, medical data, information relating to minors, to name a few, it is necessary that access to, and processing of, information being held by the system be carefully controlled. In order to do this, the system of the present invention has a security multi-layer secure data shell that enables the protection of the sensitive information being handled by the system. As indicated in FIG. 16, the use of multi-layer secure data shell 1702 is intended to be HIPPA, CCPA, GDPR (European Standard), COPPA, FERPA, PCI compliant.

Referring to FIG. 16, generally at 1700, a representative drawing of the security structure of the present invention is shown. In FIG. 16, the multi-layered secure data shell of the present invention is shown at 1702. As shown in this Figure, there are three main elements of the system. These include the input devices at 1704, processing by the multi-layered secure data shell at 1706, and outputs at 1708. As shown at 1718, the inputs to the secure data shell are related to assessments, decisions, and match requests. These inputs can come from individuals, groups, companies, and SMEs. The outputs at 1728 are only results but no raw data is output.

Looking more closely at the entities providing inputs, as seen in FIG. 16, multi-layered secure data shell 1702 receives three categories of inputs. These are from system users at 1720, SMEs at 1722, and other participants at 1724. With regard to the system users at 1720, their inputs include the preferences and priorities they desire to be part of decision-making or bias assessment process. System users also provide inputs in the form of requests, questions, and answers for effecting bias assessment and decision-making.

The second entities providing inputs to secure data shell 1702 are SMEs at 1722. As shown at 1722, SMEs provide inputs such as templates that can be used for bias assessment and decision-making The SMEs also provide various types of inputs that assist system users and participants in bias assessment and decision-making as it relates to their area(s) of expertise.

The third entities providing inputs to secure data shell 1702 are participants at 1724. These entities provide inputs associated with both decision-making and bias assessment processes. This can be as invited participants in bias assessment or as a target in decision-making or SMEs. In carrying out their roles as participants, like system users, they can provide their preferences and priorities as part of their inputs and particularly as it impacts the requests, questions, and answers input to the multi-layered secure data shell.

The outputs at 1708 are results not raw data as shown at 1728. These results can be bias assessment scores, decision Confidence Index scores, and answers to questions that imposed in a course of decision-making or bias assessment. And, it is important that the only outputs from the multi-layered secure data shell 1702 that relate to any entity's private and sensitive data, other than results, have to be specifically authorized by the entity that owns that information.

Focusing now on multi-layered secure data shell 1702, it is noted that there will be Intel repositories for securely holding “My Data” 1714 and “Other User's Data” 1716 until it is needed for either decision-making or bias assessment. Also shown in decision and assessment loop 1710, certain decisions and assessments can be carried out with only system user data and does not require any additional data from others. However, as shown at 1712, the bulk of the transactions involving bias assessment and decision-making are carried out using the system user's data and the data of others. This is the usual situation given the decision-making process involves two opposing parties and some bias assessments require additional information from others to determine the accuracy, for example, bias assessments in a company setting.

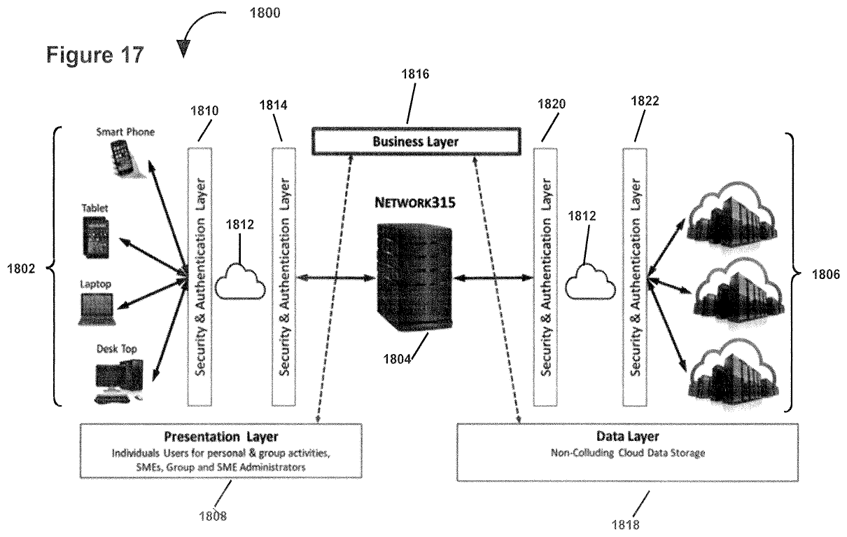

In referring to FIG. 17, generally at 1800, a representative diagram of the system of the present invention is shown. In the Figure, the system shows input and output (receiving) devices at 1802. These include, but are not limited to, smart phones, tablet devices, laptop computers, and desktop computers. These devices are part of presentation layer 1808.

A representative of the computer-based server system of the present invention is shown at 1804. Preferably, the computer-based system shown at 1804 is a scalable server system capable of handling large numbers of transactions for effecting operation of the bias assessment and decision-making processes. The computer-based server system of the present invention that is represented by the unit shown at 1804 is part of business layer 1816.

The final major element of the system of the present invention is cloud-based non-colluding data storage shown at 1806. In order to ensure the security of the data being processed by the system of the present invention, the system data is stored in non-colluding cloud data storage. The operation of non-colluding cloud data storage would be understood by a person of ordinary skill in the art to provide an environment in which information is securely stored. The non-colluding cloud data storage is part of the data layer 1818.

As shown in FIG. 17, the communications between the input and output devices at 1802 and server 1804 are cloud-based communications. Similarly, the communications between server 1804 and the non-colluding cloud data storage units 1806 are also cloud-based communications. To ensure the security of these communication paths, there is security and authentication layer 1810 that receives communications from the input device at 1802. Similarly, there is security and authentication layer 1814 on the server-side of the cloud. As a person of ordinary skill in the art would understand, this type of security on either side of cloud 1812 ensures the secure transmission of communications between the input devices and the server. The same security set up is provided for communications between server 1804 and non-colluding cloud data storage 1806. In this situation, security and authentication layer 1820 is on the server-side of cloud 1812 and server and authentication layer 1822 is on the non-colluding cloud data storage side of the communications path. As stated, the person of ordinary skill in the art would understand the operation of these security and authentication layers for communications through cloud 1812.

Noting the foregoing, the system of the present invention has been described along with its operation for carrying out bias assessments and decision-making. Moreover, the type of security being provided will enable sensitive information being processed by the system of the present invention to be safely handled.

The embodiments or portions thereof of the system and method of the present invention may be implemented in computer hardware, firmware, and/or computer programs executing on programmable computers or servers that each includes a processor and a storage medium readable by the processor (including volatile and non-volatile memory and/or storage elements). Any computer program may be implemented in a high-level procedural or object-oriented programming language to communicate within and outside of computer-based systems.

Any computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments, or portions thereof, may also be implemented as a machine-readable storage medium, configured with a computer program, where, upon execution, instructions in the computer program cause a machine to operate to perform the functions of the embodiments described above.

The embodiments, or portions thereof, of the system and method of the present invention described above may be used in a variety of applications. Although the embodiments, or portions thereof, are not limited in this respect, the embodiments, or portions thereof, may be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above may also be implemented using integrated circuit blocks referred to as main memory, cache memory, or other types of memory that store electronic instructions to be executed by a microprocessor or store data that may be used in arithmetic operations.

The descriptions are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory.

Various modifications to the disclosed embodiments will be apparent to those skilled in the art, and the general principals set forth below may be applied to other embodiments and applications. Thus, the present invention is not intended to be limited to the embodiments shown or described herein.

1. A computer-based method for generating a bias assessment score that is indicative of a level of at least hidden or unconscious bias with regard to a specific subject area, comprising the steps of:
A. selecting a potential bias subject area that a first individual may have hidden or unconscious bias;
B. develop a computer-based template that includes at least one bias profile statement directed to the potential bias subject area, at least one bias object that is a first level of statement below the bias profile statement directed to the potential bias subject area, and at least two bias dimension statements that are a first level of statement below the bias object statement and a second level of statement below the bias profile statement directed to the potential bias subject area, with each bias dimension statement including at least two parts for which the first individual is capable of providing a response to each part on a predetermined scale and uploading the template to a database of a system computer that is accessible by the first individual, wherein the first part of the two parts includes a question for a response is needed and the second part is an importance of the first part question to the first individual;
C. the first individual downloading the template and separately recording a response along the scale of each of the two parts of each of the two bias dimension statements and uploading the responses to the system computer;
D. the system computer generating a bias assessment score indicative of the level of at least hidden or unconscious bias in the first individual by
i. receiving inputs for a system dimension importance score for each bias dimension, a system object dimension score for the bias object, and an ideal object importance score,
ii. determining a bias dimension score for each bias dimension by determining a product of the first part score, the second part score, and the system dimension importance score, with a result being a first bias dimension score and a second bias dimension score,
iii. determining a bias object score by summing the first and second bias dimension scores,
iv. determining a bias profile score by summing the bias object score with any additional bias object scores and if there is just the bias object score at step D(iii), the bias profile score equals the bias object score, and
v. determining the bias assessment score for the first individual as a percentage by subtracting an absolute value between the bias profile score and the ideal object importance score from the ideal object importance score and then divided by the ideal object importance score and multiplying by 100.

2. The method as recited in claim 1, wherein the bias object statement includes a question.

3. The method as recited in claim 1, wherein the predetermine scale for first and second parts of each bias dimension includes a range.

4. The method as recited in claim 3, wherein the ranges for each bias dimension is capable of being divides into sub-ranges.

5. The method as recited in claim 4, wherein each sub-range is capable of being assigned a value for determining the bias assessment score.

6. The method as recited in claim 3, wherein each range includes having a portion thereof as acceptable for selection of a score that is capable value for determining the bias assessment score.

7. The method as recited in claim 3, wherein ranges for the first part of the bias dimension statement includes numeric or percentage ranges.

8. The method as recited in claim 3, wherein ranges for the second part of the bias dimension statement includes percentage ranges.

9. A computer-based decision-making method for generating a confidence index score to indicate a best decision option, comprising the steps of:
A. a system user selecting a decision type to conduct a decision;
B. the system user defining the subject area for which a decision is sought;
C. the system user defining sourcing for potential decision targets in the defined subject area and generating a searchable computer database for identifying potential target;
D. the system user developing a computer-based template that includes at least one decision profile statement directed to the decision subject area, at least one decision object that is a first level of statement below the decision profile statement directed to the decision subject area, and at least two decision dimension statements that are a first level of statement below the decision object statement and a second level of statement below the decision profile statement directed to the decision subject area, with each decision dimension statement including at least two parts for which the first individual is capable of providing a response to each part on a predetermined scale and uploading the template to a database of a system computer that can be retrieved the system user for transmission to decision targets, wherein the first part of the two parts includes a question for a response is needed and the second part is an importance of the first part question to a decision target;
E. the system user searching the target's searchable database with the decision profile, decision objects, and decision dimensions for matching decision targets, and receiving matched decision targets ranked by confidence index scores with the confidence index score for each decision target being determined by
i. a system computer receiving for each decision target a target's scores for the first and second parts of each decision dimension statement, the system user's importance score for each decision dimension, and an ideal target object importance score,
ii. the system computer determining a decision dimension score for each decision dimension by determining a product of the first part score, the second part score, and the system user dimension importance score, with a result being a first decision dimension score and a second decision dimension score,
iii. determining a decision object score by summing the first and second decision dimension scores,
iv. determining a decision profile score by summing the decision object score with any additional decision object scores and if there is just the decision object score at step E(iii), the decision profile score equals the decision object score, and
v. determining the confidence index score for each decision target as a percentage by subtracting an absolute value between the decision profile score and the ideal target object importance score from the ideal target object importance score and then divided by the ideal target object importance score and multiplying by 100,
F. the computer system ranking the decision targets by confidence index scores and transmitting the ranking to the system, and if the system user selects the decision target with the highest confidence index score, then end the process, otherwise step G;
G. the system user sending addition one or more additional questions to one or more decision targets and generating new confidence index scores according to step D for the decision targets and ranking the decision targets according to the new confidence index scores; and
H. repeating steps F and G until the system user selects a decision target.

10. The method as recited in claim 9, wherein the decision object statement includes a question.

11. The method as recited in claim 9, wherein the predetermine scale for first and second parts of each decision dimension includes a range.

12. The method as recited in claim 11, wherein the ranges for each decision dimension is capable of being divides into sub-ranges.

13. The method as recited in claim 12, wherein each sub-range is capable of being assigned a value for determining the confidence index score.

14. The method as recited in claim 11, wherein each range includes having a portion thereof as acceptable for selection of a score that is capable value for determining the confidence index score.

15. The method as recited in claim 11, wherein ranges for the first part of the decision dimension statement includes numeric or percentage ranges.

16. The method as recited in claim 11, wherein ranges for the second part of the decision dimension statement includes percentage ranges.
